(19) United States
(12) Patent Application Publication
(10) Pub. No.: US 2026/0371181 A1
(43) Pub. Date: Nov. 19, 2026

(54) TRIGGERED MOBILITY WITH CELL ACTIVATION AND DEACTIVATION

(71) Applicant: QUALCOMM Incorporated, San Diego, CA (US)

(72) Inventors: Qing LI, Princeton Junction, NJ (US); Navid ABEDINI, Basking Ridge, NJ (US); Jelena DAMNJANOVIC, Del Mar, CA (US); Junyi LI, Greentown, PA (US); Tao LUO, San Diego, CA (US)

(21) Appl. No.: 19/330,579

(22) Filed: Sep. 16, 2025

Related U.S. Application Data
(60) Provisional application No. 63/806,667, filed on May 15, 2025.
(60) Provisional application No. 63/806,634, filed on May 15, 2025.

(51) Int. Cl. H04W 36/00; H04W 24/10

(52) U.S. Cl. CPC H04W 36/0061; H04W 24/10

(57) ABSTRACT

Certain aspects of the present disclosure provide techniques for signaling techniques for mobility with cell activation and deactivation. An example method, performed at a first wireless node, generally includes configuring a second wireless node with at least one candidate cell and at least one of: a first list indicating one or more of the at least one candidate cell that are active, and a second list indicating one or more of the at least one candidate cell that are inactive, obtaining information regarding one or more network conditions, performing one or more actions to activate one or more candidate cells in the second list or deactivate one or more candidate cells in the first list based on the information, and providing, after performing the one or more actions, to the second wireless node an update regarding at least one of the first list or the second list.

### CROSS-REFERENCE TO RELATED APPLICATIONS

This application claims priority to U.S. Provisional Application No. 63/806,667, filed May 15, 2025, and U.S. Provisional Application No. 63/806,634, filed May 15, 2025, which are both assigned to the assignee hereof and hereby expressly incorporated by reference in their entireties as if fully set forth below and for all applicable purposes.

### FIELD OF THE DISCLOSURE

Aspects of the present disclosure relate to wireless communications, and more particularly, to signaling techniques for mobility with cell activation and deactivation.

### DESCRIPTION OF RELATED ART

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communication at a first wireless node. The method includes configuring a second wireless node with at least one candidate cell and at least one of: a first list indicating one or more of the at least one candidate cell that are active, and a second list indicating one or more of the at least one candidate cell that are inactive; obtaining information regarding one or more network conditions; performing one or more actions to activate one or more candidate cells in the second list or deactivate one or more candidate cells in the first list based on the information; and providing, after performing the one or more actions, to the second wireless node an update regarding at least one of the first list or the second list.

Another aspect provides a method for wireless communication at a second wireless node. The method includes obtaining, from a first wireless node, signaling configuring the first wireless node with at least one candidate cell and at least one of: a first list indicating one or more of the at least one candidate cell that are active, and a second list indicating one or more of the at least one candidate cell that are inactive; and obtaining, from the first wireless node, an update regarding at least one of the first list or the second list.

Another aspect provides a method for wireless communication at a first wireless node. The method includes obtaining, from a second wireless node, signaling indicating at least one candidate cell and at least one of: a first list indicating one or more of the at least one candidate cell that are active, and a second list indicating at least one candidate cell that is inactive, wherein the first wireless node is associated with a candidate cell in the first list or the second list; and obtaining, from the second wireless node, a request to activate or deactivate the candidate cell associated with the first wireless node.

One aspect provides a method for wireless communication. The method includes configuring a wireless node with a set of candidate cells with one or more respective configurations associated with synchronization signal block (SSB) adaptation; obtaining information regarding one or more network conditions; performing one or more actions to activate or deactivate SSB adaptation associated with a first subset of one or more of the set of candidate cells, according to the configurations, based on the information; and providing, after performing the one or more actions, to the wireless node an update regarding the activation or the deactivation of SSB adaptation.

Another aspect provides a method for wireless communication at a first wireless node. The method includes obtaining, from a second wireless node, signaling configuring the first wireless node with a set of candidate cells with one or more respective configurations associated with synchronization signal block (SSB) adaptation; outputting, to the second wireless node after obtaining the signaling, information regarding one or more network conditions; and obtaining, from the second wireless node, an update regarding activation or deactivation of SSB adaptation for one or more candidate cells of the set.

Another aspect provides a method for wireless communication. The method includes obtaining, from a wireless node, signaling indicating a set of candidate cells with one or more respective configurations associated with synchronization signal block (SSB) adaptation; providing, to the wireless node, information regarding one or more network conditions; and obtaining, from the wireless node, a request to activate or deactivate SSB adaptation for a first subset of one or more candidate cells of the set, according to the configurations for SSB adaptation.

Other aspects provide: an apparatus operable, configured, or otherwise adapted to perform any one or more of the aforementioned methods and/or those described elsewhere herein; a non-transitory, computer-readable media comprising instructions that, when executed (e.g., directly, indirectly, after pre-processing, without pre-processing) by one or more processors of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIG. 5 depicts an example scenario with a pre-configured candidate cell set.

FIG. 6 depicts an example of UE mobility.

FIG. 7 depicts an example lower-layer triggered mobility (LTM) report without differential reporting.

FIG. 8 depicts a call flow diagram for LTM mobility.

FIG. 9 depicts a call flow diagram for LTM mobility with cell activation, in accordance with certain aspects of the present disclosure.

FIG. 10 depicts a call flow diagram for LTM mobility with cell deactivation, in accordance with certain aspects of the present disclosure.

FIG. 11 depicts a call flow diagram for inter control unit (inter-CU) LTM mobility with cell activation, in accordance with certain aspects of the present disclosure.

FIG. 12 depicts a call flow diagram for inter-CU LTM mobility with cell deactivation, in accordance with certain aspects of the present disclosure.

FIG. 13 depicts a call flow diagram for LTM mobility with synchronization signal block (SSB) adaptation activation, in accordance with certain aspects of the present disclosure.

FIG. 14 depicts a call flow diagram for LTM mobility with SSB adaptation deactivation, in accordance with certain aspects of the present disclosure.

FIG. 15 depicts a call flow diagram for inter-CU LTM mobility with SSB adaptation activation, in accordance with certain aspects of the present disclosure.

FIG. 16 depicts a call flow diagram for inter-CU LTM mobility with SSB adaptation deactivation, in accordance with certain aspects of the present disclosure.

FIG. 17 depicts a method for wireless communications.

FIG. 18 depicts a method for wireless communications.

FIG. 19 depicts a method for wireless communications.

FIG. 20 depicts a method for wireless communications.

FIG. 21 depicts a method for wireless communications.

FIG. 22 depicts a method for wireless communications.

FIG. 23 depicts aspects of an example communications device.

### DETAILED DESCRIPTION

Aspects of the present disclosure relate to wireless communications, and more particularly, to signaling techniques for mobility with cell activation and deactivation.

In advanced wireless systems, mobility procedures are in place to help maintain network connections for user equipment (UE) as it moves between the coverage areas of different cells. Mobility procedures generally refer to mechanisms that allow a UE to transition from being served by a source cell to being served by a target/candidate cell, which may generally be referred to as handover.

In some cases, for physical layer (PHY or Layer 1/L1) and/or medium access control layer (MAC or Layer 2/L2), also referred to as L1/L2 triggered mobility (LTM), as a UE moves, a new serving cell (e.g. a primary cell (Pcell)) may be selected (e.g., reselected) for handover among a set of pre-configured candidate cells based on measurements of reference signal (RS) made at the physical (PHY or L1) layer (referred to as L1 measurements) for those cells. The RSs are typically sent with different beams. To facilitate a handover decision, the UE may generate beam reports containing information about the received signal quality from the different beams of the serving cell and/or candidate cells. These beam reports may then be sent to a serving cell. For example, such beam reports may include measurements (e.g., reference signal (RS) receive power (RSRP), signal to interference and noise ratio (SINR)) for M beams for each of L (serving and/or candidate) cells. Thus, the reports may include M×L total measurements.

In an open radio access network (O-RAN) scenario, a UE may send a radio resource control (RRC) measurement report. In this context, an RRC measurement report refers to a message sent by the UE to the O-RAN network (e.g., to a distributed unit (DU), containing data about the signal quality of nearby cells. Information in the report may allow the network to make informed decisions like handovers, based on the measured signal strength and other parameters, using the Radio Resource Control (RRC) protocol within the O-RAN architecture.

LTM candidate cells are typically statically or semi-statically configured. In such cases, the LTM candidate cells may be expected to be fully active (“always-on”) transmitting synchronization signal blocks (SSBs) for LTM measurements, LTM pre-synchronization and LTM cell switches. Giving different traffic loading at different times and locations, some LTM candidate cells operating in an always-on state may be underutilized, which wastes energy.

Aspects of the present disclosure, provide signaling mechanisms that may support dynamic activation and deactivation of LTM candidate cells. For example, the mechanisms may allow for network energy savings by activating or deactivating LTM candidate cells based on certain criteria, such as changes in traffic loading and channel conditions.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

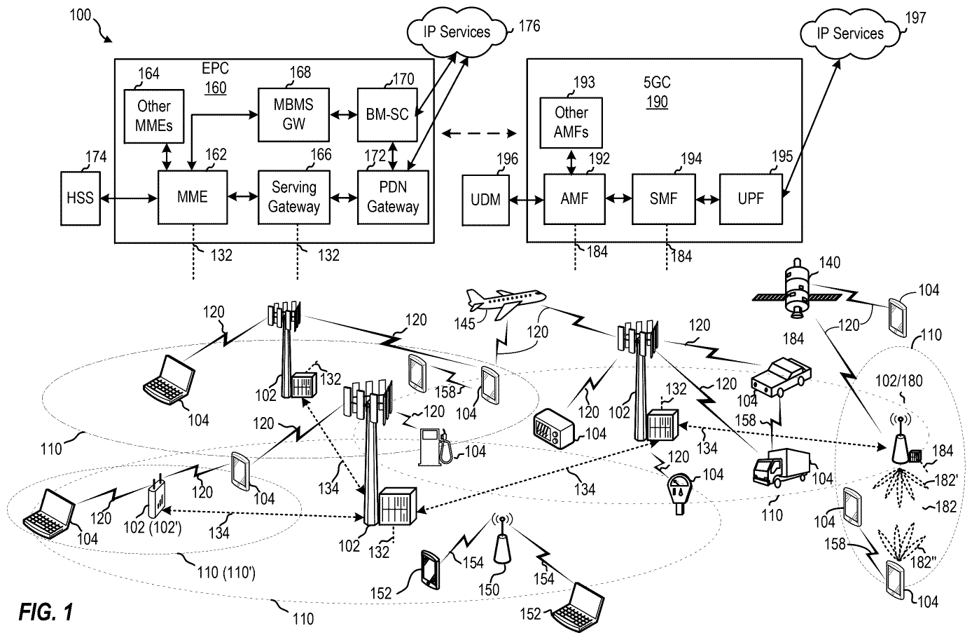

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

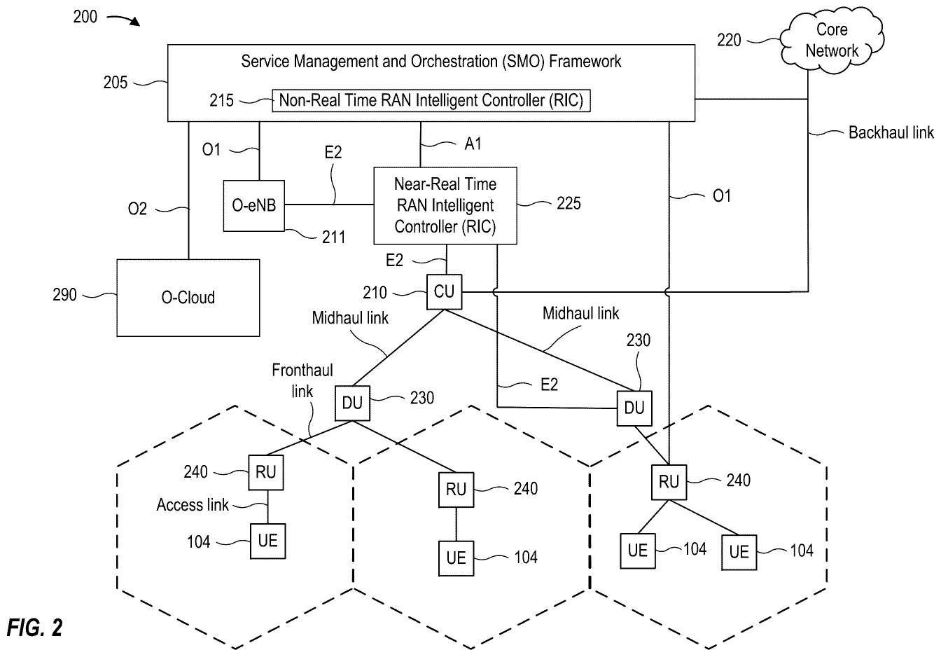

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR 1) as including 410 MHz-7125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information. 5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

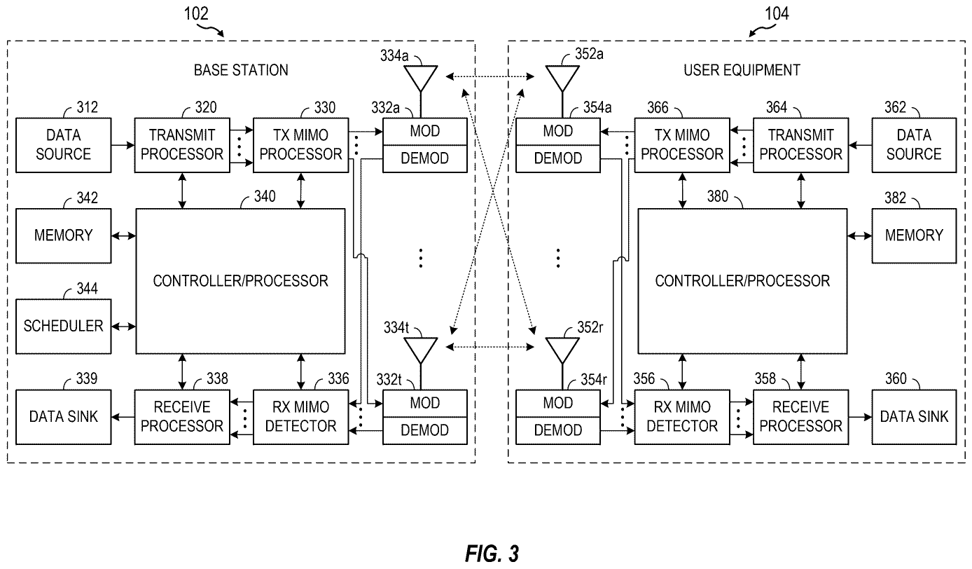

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, one or more processors may be configured to perform various operations, such as those associated with the methods described herein, and transmit (output) to or receive (obtain) data from another interface that is configured to transmit or receive, respectively, the data.

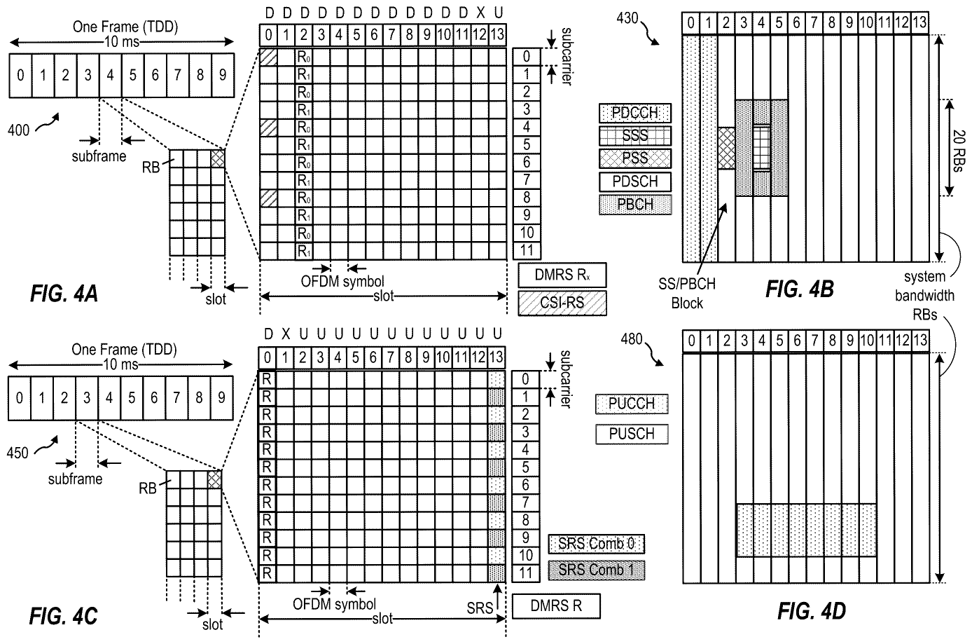

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 6 allow for 1, 2, 4, 8, 16, 32, and 64 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2 μ slots/subframe. The subcarrier spacing and symbol length/duration are a function of the numerology. The subcarrier spacing may be equal to 2^{μ}×15 kHz, where μ is the numerology 0 to 6. As such, the numerology μ=0 has a subcarrier spacing of 15 kHz and the numerology μ=6 has a subcarrier spacing of 960 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Overview of Lower-Layer Triggered Mobility (LTM)

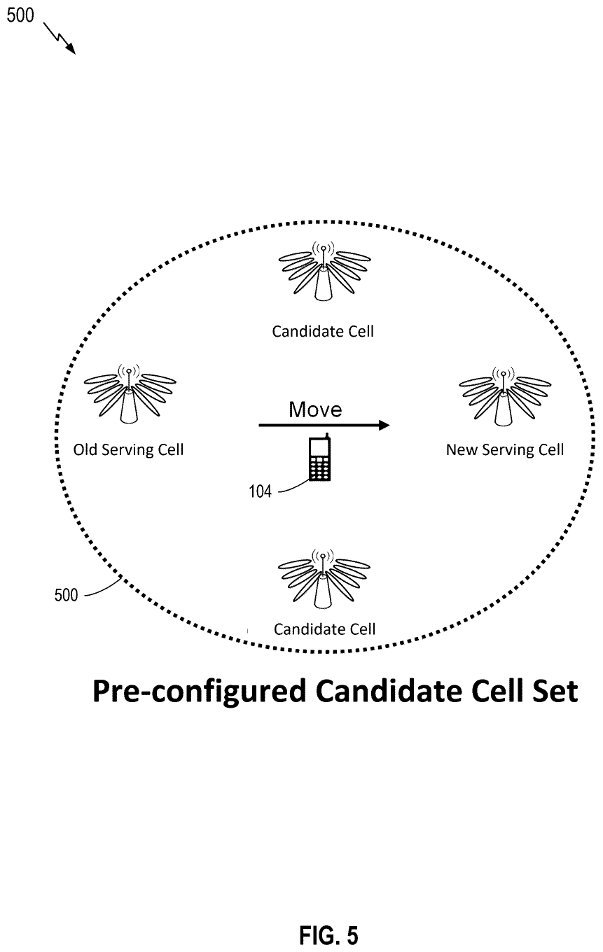

Dynamic mobility signaling may be beneficial in the scenario illustrated in FIG. 5, where a UE may move between a preconfigured set 500 of candidate cells. In the illustrated example, the UE moves from a first cell (e.g., an old serving/primary cell) to a new serving candidate cell. In this case, the UE may not receive data or control information in the candidate cell, but may transmit a PRACH in order to facilitate timing adjustment for the new candidate cell before a cell change.

As noted above, dynamic mobility signaling (e.g., L1 and/or L2-centric mobility or LTM) may lead to more efficient intra-cell and inter-cell mobility with reduced latency.

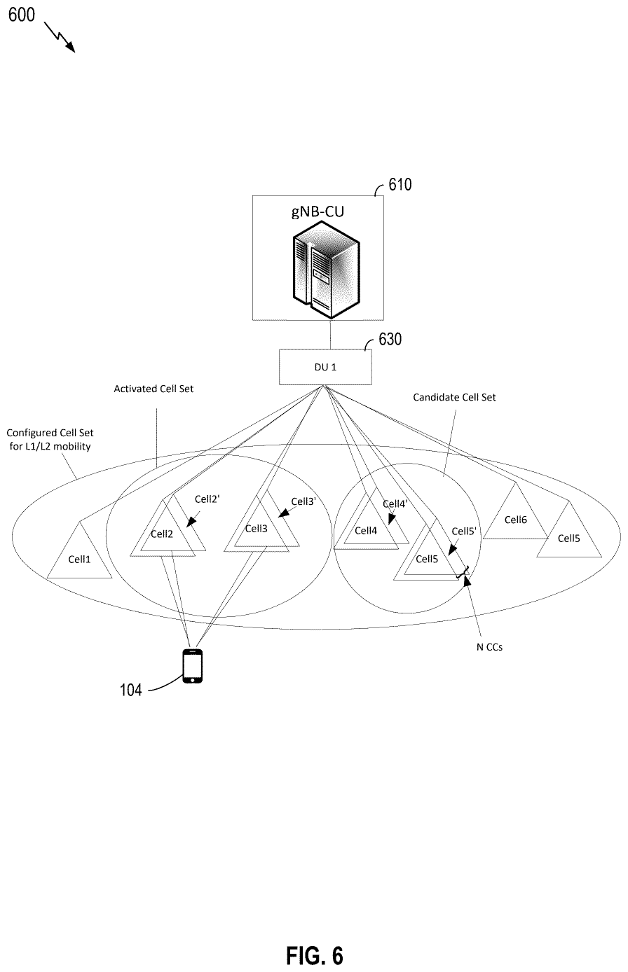

The general concept of LTM signaling may be understood with reference to the example scenario 600 shown in FIG. 6. As illustrated, the network may configure (e.g., via RRC signaling), a set of cells for L1/L2 mobility (referred to herein as an L1/L2 Mobility Configured cell set). At any given time, the network may also configure (via L1/L2 signaling) an L1/L2 Mobility Activated cell set, which refers to a group of cells in the configured set that are activated and can be readily used for data and control transfer.

As in the example illustrated in FIG. 6, in some cases, all cells in the L1/L2 Mobility Configured cell set may belong to the same DU 630 of a CU 610. This may be similar to carrier aggregation (CA), but cells may be on the same carrier frequencies. The size of the cell set configured for L1/L2 mobility signaling may vary. In general, the cell set size may be selected to be large enough to cover a meaningful mobility area.

As illustrated in FIG. 6, each cell may be served by an RU. Each of the RUs may have multi-carrier (N CCs) support. In such cases, each CC may be a cell (e.g., Cell 2 and Cell 2′ may be different CCs of the same RU). In such cases, L1/L2 mobility may be handled at the DU to which the RUs are associated, e.g., intra-DU case.

For PCell management, L1/L2 signaling may be used to set (select) the PCell out of the preconfigured options within the candidate cell set. In some cases, L3 mobility may be used for PCell change (L3 handover) when a new PCell is not from the candidate cell set for L1/L2 mobility. In such cases, RRC signaling may update the set of candidate cells for L1/L2 mobility at L3 handover.

In some cases, physical layer (Layer 1 or L1) measurement may be enhanced for L1/L2 mobility, where a serving cell can be changed via L1/L2 signalling based on L1/L2 measurement, and both synchronous and asynchronous source and target cells may be considered.

Various mechanisms and procedures of L1/L2 based inter-cell mobility may be specified for mobility latency reduction. These may include configuration and maintenance for multiple candidate cells to allow fast application of configurations for candidate cells. Dynamic switching mechanisms among candidate serving cells (including SpCell and SCell) may be supported for the potential applicable scenarios based on L1/L2 signaling.

L1 enhancements for inter-cell beam management may include L1 measurement and reporting, as well as beam indication. Timing Advance (TA) management and CU-DU interface signaling may also be provided to support L1/L2 mobility.

L1/L2 based inter-cell mobility procedures may be applicable to a variety of scenarios. These scenarios may include standalone, CA and new radio-dual connectivity (NR-DC) cases with serving cell change within one cell group (CG), intra-distributed unit (DU) cases and intra-central unit (CU) inter-DU cases, intra-frequency and inter-frequency scenarios, both FR1 and FR2 scenarios, and scenarios where source and target cells may be synchronized or non-synchronized.

As noted above, a UE may generate beam reports containing information about the received signal quality of RSs transmitted from the different beams of the serving cell and/or candidate cells, facilitating handover decisions. These beam reports may then be sent to the serving cell (base station). For example, such beam reports may include measurements for M beams for each of L (serving and/or candidate) cells.

The UE may provide the report to a serving cell, facilitating handover decisions and mobility procedures. The differential reporting may include various formats, increasing the number of beams that may be reported while significantly reducing overhead associated with processing the beam report.

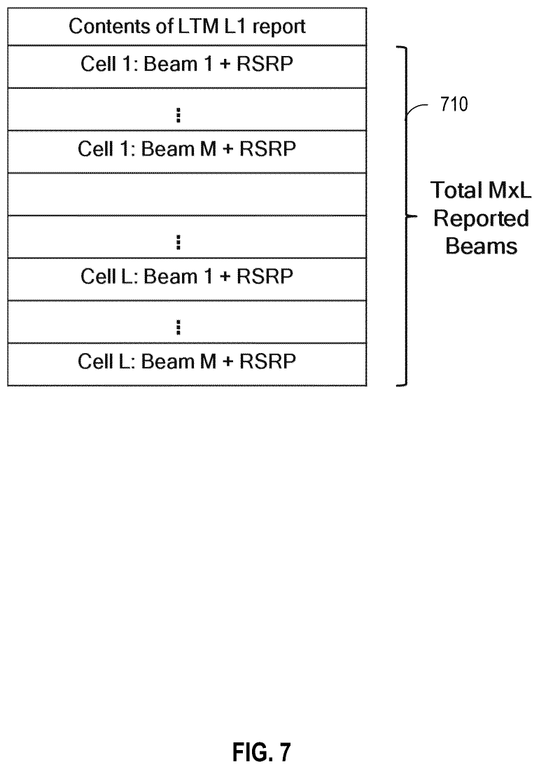

FIG. 7 depicts an example LTM report. As illustrated at 702, a single LTM report may include measurements for M beams for each of L configured (e.g., or activated, if introduced) cells. In some cases, the selection of the M beams may be determined at a UE.

Maximum values of M and L (e.g., the total number of beams that may be reported in a single LTM report) may be based on UE capability. For example, in some cases, M*L=4 beams may be supported as a UE capability. In some cases, the values of M and L may be configured to the UE in a reporting configuration.

As illustrated in FIG. 7, the example LTM report indicates an absolute RSRP value associated with each beam. As noted above, these conventional techniques for beam reporting limit the number of beams that may be included in the report and are associated with significant overhead.

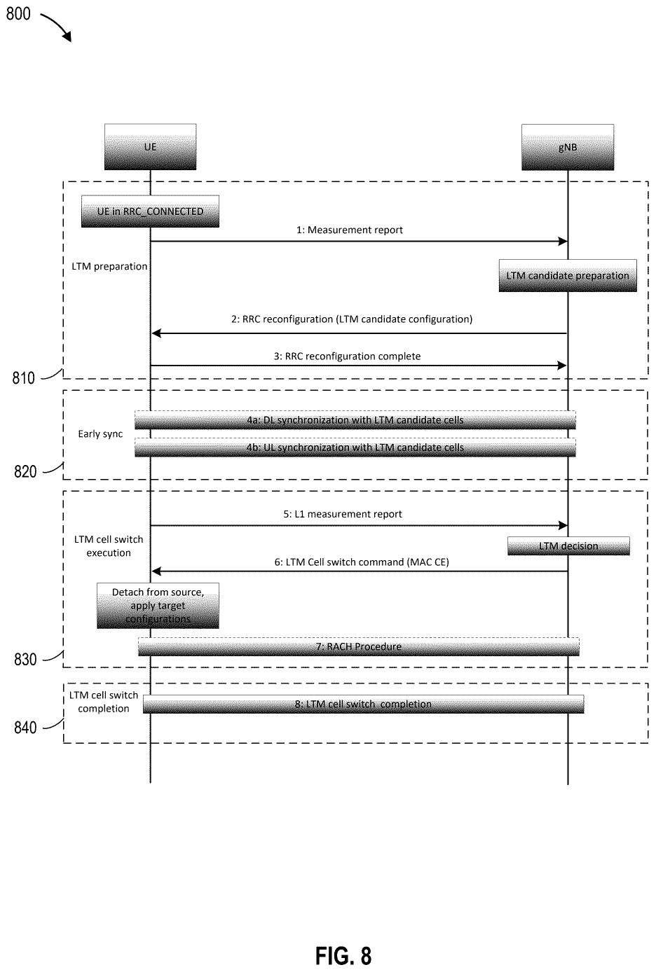

LTM may be understood with reference to the call flow diagram 800 of FIG. 8 which shows enumerated steps. In some aspects, the UE shown in FIG. 8 may be an example of the UE 104 depicted and described with respect to FIGS. 1 and 3. In some aspects, the gNB-CU and (source and candidate) gNB-DUs shown in FIG. 8 may be examples the CU 210 and DU 230 depicted and described with respect to FIG. 2.

As illustrated, the enumerated steps may be grouped into an LTM preparation phase 810, an early synchronization phase 820, an LTM cell switch execution phase 830, and an LTM cell switch completion phase 840.

In the LTM preparation phase 810, the UE sends an LTM measurement report. Based on reported measurements, the serving gNB configures the UE with LTM candidate cell configurations and the UE stores the configurations.

In the early synchronization phase 820, the UE performs DL pre-synchronization with LTM candidate cell(s), based on transmission configuration indicator (TCI) state(s) of LTM candidate cell(s) activated or deactivated by the serving gNB. For UL pre-synchronization with LTM candidate cell(s), the timing advance (TA) of an LTM candidate cell may be derived by the UE from the DL measurement of the LTM candidate cell or early TA acquisition via contention free random access (CFRA) to an LTM candidate cell triggered by PDCCH order from the serving gNB. TCI states for LTM candidate cell(s) may be activated for DL and UL synchronization.

The LTM cells switch execution phase 830 assumes that the serving gNB decides to perform an LTM cell switch based on UE's L1 measurements. The serving gNB thus transmits an LTM cell switch command MAC CE which contains various information, such as an index of a target cell configuration, a TA (if any), TCI state ID(s), and optional CFRA resource (preamble). The UE may perform a RACH-less LTM cell switch (e.g., configured grant with a TA) or a RACH LTM cell switch as illustrated in FIG. 8 (e.g., without a TA), based on the stored target cell configuration.

In the LTM cell switch completion phase, 840, the UE may send a RRCReconfigurationComplete message to the target LTM cell.

### Aspects Related to LTM With Cell Activation and Deactivation

As noted above, LTM candidate cells are typically statically or semi-statically configured, wherein the LTM candidate cells may be expected to be fully active, transmitting synchronization signal blocks (SSBs) for LTM measurements, LTM pre-synchronization and LTM cell switches. Giving different traffic loading at different times and locations, some LTM candidate cells operating in an always-on state may be underutilized, which wastes energy.

Aspects of the present disclosure, provide signaling mechanisms that may support dynamic activation and deactivation of LTM candidate cells. For example, the mechanisms may allow for network energy savings by activating or deactivating LTM candidate cells based on certain criteria, such as changes in traffic loading and channel conditions.

In some cases, inactive and active LTM candidate cells may differ in whether or how they transmit SSBs, which may impact their visibility and behaviour. For example, if an inactive LTM candidate cell does not transmit any SSB, the LTM candidate cell cannot be observed or measured by a UE. As a result, that inactive LTM candidate cell may not be considered for LTM DL or UL pre-synchronization or LTM cell switch.

On the other hand, if an inactive LTM candidate cell transmits limited or sparse SSB (always-on SSB), the LTM candidate cell can be observed or measured by a UE. Based on the UE's LTM measurement report, the inactive LTM candidate cell may be selected for DL or UL pre-synchronization, as well as LTM cell switch. However, with sparsely transmitted SSB, it may take a longer time for the UE to collect LTM measurements, as well as perform DL or UL pre-synchronization.

If an active LTM candidate cell transmits partial or full sets of SSBs, the LTM candidate cell can be observed or measured by a UE. Based on the UE's LTM measurement report, the active LTM candidate cell can be selected for DL or UL pre-synchronization, as well as LTM cell switch.

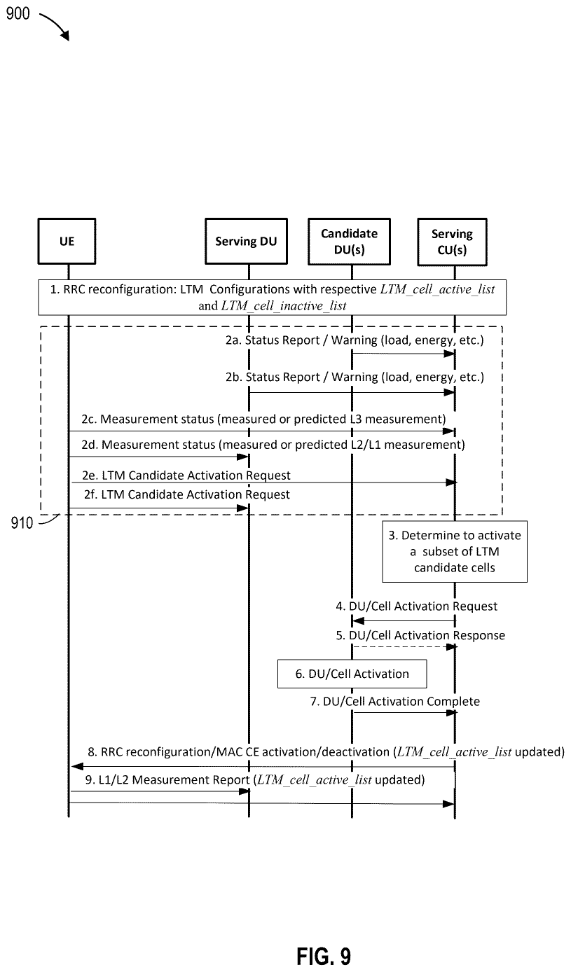

LTM with candidate cell activation and deactivation proposed herein may be understood with reference to the call flow diagrams of FIGS. 9-12. In some aspects, the UE shown in FIGS. 9-12 may be an example of the UE 104 depicted and described with respect to FIGS. 1 and 3. In some aspects, the (serving and candidate) CUs and (serving and candidate) DUs shown in FIGS. 9-12 may be examples the CU 210 and DU 230 depicted and described with respect to FIG. 2.

Referring first to call flow diagram 900 of FIG. 9, an example of dynamic LTM candidate cell activation is shown. The illustrated example assumes activation of LTM candidate cells (with DUs) under management of a serving CU (or one of the serving CUs in the case of shared DUs).

As illustrated at step 1, the UE may be configured with LTM configurations. The LTM configurations may include LTM configurations of active LTM candidate cells which may be identified in a list (e.g., LTM_cell_active_list). These LTM candidate cells may be default active cells (e.g., always on) for coverage or that have been activated already via LTM cell activation procedure.

The LTM configurations may also include LTM configurations of inactive LTM candidate cells which may be identified in a list (e.g., LTM_cell_inactive_list). These LTM candidate cells may be default inactive cells (e.g., on-demand) for coverage enhancement or offloading traffic or that otherwise have not been activated yet (e.g., for energy saving) via the LTM cell activation procedure.

As indicated at 910, via steps 2a-2f, the Serving CU may receive various types of information that can be used for determine whether to activate and/or deactivate one or more of the configured LTM candidate cells.

As illustrated (at 2a/2b), the information may come from LTM candidate DUs or the serving DU. In this context, LTM candidate DUs may refer to an active LTM candidate DUs/Cells, which may be serving DU/Cells for other UEs already or inactive LTM candidate DUs/Cells with SSBs transmitted, while a Serving DU may refer to a DU serving the UE currently. Such DUs may send a Status Report message (e.g., Resource Status Response message for one time response or Resource Status Update message for periodic response), for example, based on the Serving CU's Status Request (e.g., Resource Status Request message).

The status report may include various information regarding the DUs/Cells'status that may be useful for activating inactive LTM candidate DUs/Cells for various purposes (e.g., for offloading or enhancing coverage with additional activated LTM candidate DUs/Cells). Such information may include, for example, an indication of resource overloading, energy overconsumption, overload of UEs, or unsatisfied UEs. Resource overloading may indicate, for example, a hardware/processing load above a threshold (e.g., at least a first threshold threshold_Process_High associated with one or more activate LTM candidate cells within LTM_cell_active_list) or an uplink or downlink load above a threshold (e.g., at least a second threshold threshold_UL_High or threshold_DL_High associated with one or more activate LTM candidate cells within LTM_cell_active_list). Energy overconsumption may indicate energy/power consumption (e.g., total or average) above a threshold or energy/power consumption percentage above a threshold (e.g., at least a third threshold threshold_Energy_High associated with one or more activated LTM candidate cells within LTM_cell_active_list). Overload of UEs may indicate, for example, a number of active UEs (e.g., UEs with good connection for UL or DL communications) with measurements above a threshold (e.g., at least a fourth threshold threshold_UEconnect_High associated with one or more activate LTM candidate cells with LTM_cell_active_list). Unsatisfied UEs (e.g., UEs with poor connection) may indicate, for example, a number of UEs with measurements below a threshold (e.g., at least a fifth threshold threshold_UEconnect_Low associated with one or more activate LTM candidate cells with LTM_cell_active_list).

In some aspects, LTM candidate DUs or the serving DU may initiate one or more transmissions of a Status Report message, for example, based on one or more thresholds (e.g., a set of thresholds corresponding respectively to hardware/processing load, uplink or downlink load, energy consumption, active UEs, unsatisfied UEs, or the like).

Furthermore, according to certain aspects, LTM candidate DUs or the Serving DU may send a status warning message to the Serving CU (e.g., via/as a DU Status Indication message) indicating a status warning such as an overload (e.g., process load or UL/DL load above a threshold (e.g., for a normal operation)) or energy overconsumption (e.g., energy consumption above a threshold or percentage of energy above a threshold (e.g., as budgeted for network energy saving)) or too many UEs to support (e.g., number of connected UEs above a threshold (e.g., to ensure the QoS of communication)).

As illustrated (at 2c/2d), the UE may send various types of information that may allow for enhancing coverage with additional active LTM candidate DUs/Cells. For example, such information may be conveyed via a measurement status message to the Serving CU/DU (e.g., a UE Assistance Information message or L3/L2/L1 report message). Such a message may include the measured or predicted results that do not satisfy conditions expected to maintain a reliable connection or user experience of a service with the current Serving DU/Cell. For example, the results may include the highest L3/L2/L1 measurements (measured or predicted) that may be expected to trigger a radio link failure (RLF) in the near future with the Serving DU/Cell. The report may also include measured or predicted results not satisfying conditions to select an LTM candidate cell for cell switching, such as the highest L3/L2/L1 measurements (measured or predicted) that may not meet the requirement of cell (re)selection with LTM candidate cells (e.g., need LTM candidate cells with better connection).

As illustrated (at 2e/2f), in some cases, the UE may send a request (e.g., an LTM Candidate Activation Request) for activating inactive LTM candidate cells, for example, based on the measurement status (e.g., that indicate a need for LTM candidate cells with better connection). Such a request may be sent, for example, to the serving CU(s), via an RRC message, or to the Serving DU, via a MAC CE, UCI or an Uplink-Wakeup Signal (UL-WUS) or similar type of signal (e.g., with an implicit or explicit indication of “activation”). While the activation request is shown as coming from the UE, similar requests could also come from the serving DU/cell or candidate DU/cell(s), for example, based on the status of load, energy, UEs, or the like.

As illustrated (at 3), the Serving CU may determine to activate a subset of its inactive LTM candidate cells (e.g., for intra-CU case) based at least on the received messages. The serving CU may then perform one or more actions to activate the subset of inactive cells. For example, as illustrated (at 4), the serving CU may transmit a message (e.g., a DU/Cell Activation Request message) to inactive LTM candidate DUs/cells to initiate the activation. The message may include a list of inactive DU/cells to be activated (e.g., an activate_DU/cell_list).

Optionally (as indicated at 5), the inactive LTM candidate DU/cells may respond with a DU/Cell Activation Response to accept or reject the activation request. As indicated (at 6), the inactive LTM candidate DU/cells may conduct the activation accordingly. As indicated (at 7), the activated LTM candidate DU/cells may indicate the activation completion (e.g., with a DU/Cell Activation Complete or DU/Cell Activation Failure message).

Additionally, or alternatively, the Serving DU may determine to activate a subset of its inactive LTM candidate cells (e.g., for intra-DU case) based at least on the received messages (e.g., loading or energy status report or warning message from its LTM cells or measurement status report from UEs, or LTM Cell Activation Request from its LTM cells or UEs). The serving DU may then perform one or more actions to activate the subset of its inactive cells. For example, the serving DU may transmit a message (e.g., a Cell Activation Request message) to its inactive LTM candidate cells to initiate the activation. The message may include a list of inactive cells to activate (e.g., an activate_cell_list). Optionally, the inactive LTM candidate cells may respond with a Cell Activation Response to accept or reject the activation request. Accordingly, the inactive LTM candidate cells may conduct the activation. The activated LTM cells may indicate the activation completion (e.g., with a Cell Activation Complete or Cell Activation Failure message). Furthermore, the Serving DU may indicate the activated cells to the Serving CU (e.g., with an activate_cell_list).

The serving CU may then notify the UE of the update to the active LTM candidate cells (e.g., as described above for intra-CU or intra-DU cases). For example, as indicated at 8, the serving CU may transmit an RRC reconfiguration (with the additionally active LTM candidate cells (e.g., add to the LTM_cell_active_list and remove from the LTM_cell_inactive_list) or activation MAC CE/DCI to the UE for updated LTM configurations (e.g., updated LTM_cell_active_list and LTM_cell_inactive_list). As indicated at 9, the UE may then report L1/L2 measurements to the serving DU/cell or L3 measurements to the serving CU based on the updated active LTM candidate DUs/Cells (e.g., LTM_cell_active_list).

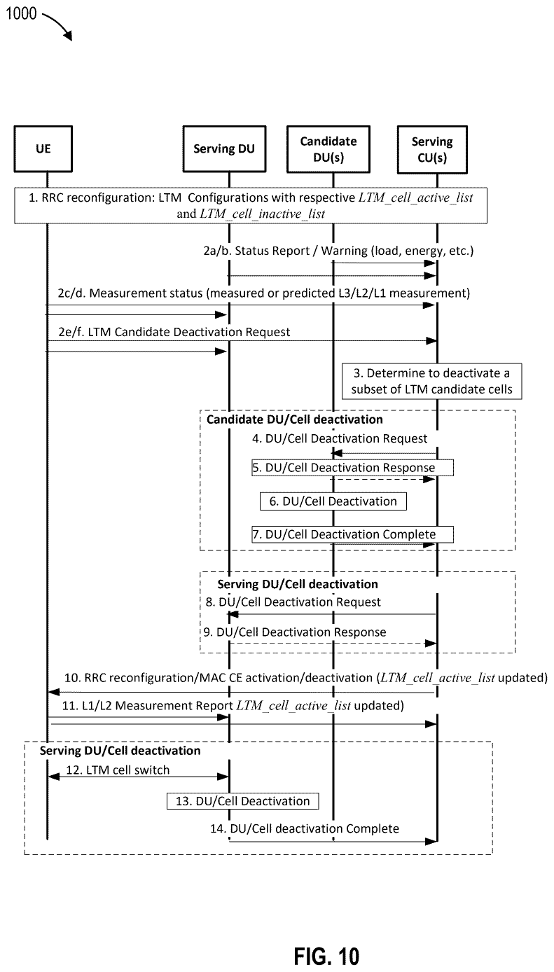

Referring next to call flow diagram 1000 of FIG. 10, an example of dynamic LTM candidate cell deactivation is shown. The illustrated example assumes deactivation of LTM candidate cells under management of the serving CU(s).

As illustrated, steps 1-2f may be performed in a same or similar manner, as described above with reference to FIG. 9 (e.g., overloading or energy overconsumption, or the like), providing the serving CU(s) with information for making LTM candidate deactivation decisions (e.g., system underutilization, energy inefficiency, poor UE experience, or the like).

For example, the status report may include various information regarding the DUs/Cells'status that may be useful for deactivating the active LTM candidate DUs/Cells for more energy saving. Such information may include, for example, an indication of system underutilization, energy inefficiency, or the like. System underutilization may indicate, for example, a hardware/processing load below a threshold (e.g., at least a first threshold associated threshold_Process_Low with one or more activate LTM candidate cells within LTM_cell_active_list) or an uplink or downlink load below a threshold (e.g., at least a second threshold threshold_UL_Low or threshold_DL_Low associated with one or more activate LTM candidate cells within LTM_cell_active_list). Energy inefficiency may indicate average energy/power consumption (e.g., per operation or per service or per UE) above a threshold or average energy/power consumption percentage (e.g., per operation or per service or per UE) above a threshold (e.g., at least a third threshold threshold_Energy_Average associated with one or more activate LTM candidate cells within LTM_cell_active_list). Connection of UEs may indicate, for example, a number of UEs with good connections for UL or DL communications below a threshold or the number of UEs with poor connections for UL or DL communications above a threshold (e.g., at least a fifth threshold threshold_UE_GoodConnect_Low or threshold_UE_PoorConnect_High associated with one or more activate LTM candidate cells within LTM_cell_active_list).

In some aspects, LTM candidate DUs or the serving DU may initiate one or more transmissions of a Status Report message, for example, based on one or more thresholds (e.g., a set of thresholds corresponding respectively to system underutilization, uplink or downlink resources underutilization, energy inefficiency, low UE experiences of the services (e.g., low number of UEs with good connections or high number of UEs with poor connections, or the like).

Furthermore, according to certain aspects, LTM candidate DUs or the Serving DU may send a status warning message to the Serving CU (e.g., via/as a DU Status Indication message) indicating a status warning such as an underutilization (e.g., process load or UL/DL load below a threshold (e.g., for a normal operation)) or energy inefficiency (e.g., average energy consumption above a threshold or average percentage of energy above a threshold (e.g., as budgeted for network energy saving)) or too many UEs with poor connections (e.g., number of connected UEs with good connections below a threshold (e.g., meeting QoS requirements) and number of connected UEs with poor connections above a threshold (e.g., missing QoS requirements)).

As illustrated (at 2c/2d), the UE may send various types of information that may allow for improve energy saving as well as meeting QoS requirements with additional inactive/deactivated LTM candidate DUs/Cells. For example, such information may be conveyed via a measurement status message to the Serving CU/DU (e.g., a UE Assistance Information message or L3/L2/L1 report message). Such a message may include the measured or predicted results that do not satisfy conditions expected to maintain a reliable connection or user experience of a service with the current Serving DU/Cell. For example, the results may include the highest L3/L2/L1 measurements (measured or predicted) that may be expected to trigger a radio link failure (RLF) in the near future with the Serving DU/Cell.

As illustrated (at 2e/2f), in some cases, the UE may send a request (e.g., an LTM Candidate Deactivation Request or LTM Candidate Activation Request with a deactivation_flag) for deactivating active LTM candidate cells to support network energy saving, for example, based on the measurement status (e.g., deactivate LTM candidate cells with poor connection). As with the LTM candidate activation request described in FIG. 9, such a deactivation request may be sent, for example, to the serving CU(s), via an RRC message, or to the Serving DU, via a MAC CE, UCI or an Uplink-Wakeup Signal (UL-WUS) or similar type of signal (e.g., with an implicit or explicit indication of “deactivation”). While the deactivation request is shown as coming from the UE, similar requests could also come from the serving DU/cell or candidate DU/cell(s), for example, based on the status of underutilization, low energy efficiency, UEs with poor connections, or the like.

As illustrated (at 3), the Serving CU may determine to deactivate a subset of its active LTM candidate cells (e.g., intra-CU case) based at least on the received messages. The determination may be made, for example, for saving energy with reduced active LTM candidate DUs/Cells. The serving CU may then perform one or more actions to deactivate the subset of inactive cells. For example, as illustrated (at 4), the serving CU may transmit a message (e.g., a DU/Cell Activation Request message with a deactivation_flag or a DU/Cell Deactivation Request message) to its active LTM candidate DUs/cells to initiate the deactivation. The message may include a list of active DU/cells to be deactivated (e.g., a deactivate_DU/cell_list).

Optionally (as indicated at 5), the active LTM candidate DU/cells may respond with a DU/Cell Activation Response message with a deactivation_flag or a DU/Cell Deactivation Response to accept or reject the deactivation request (e.g., with a deactivate_DU/cell_list). As indicated (at 6), the active LTM candidate DU/cells may conduct the deactivation accordingly. As indicated (at 7), the deactivated LTM candidate DU/cells may indicate the deactivation completion (e.g., with a DU/Cell Activation Complete/Failure message with a deactivation_flag or a DU/Cell Deactivation Complete or DU/Cell Deactivation Failure message).

Additionally, or alternatively, the Serving DU may determine to deactivate a subset of its active LTM candidate cells (e.g., for intra-DU case) based at least on the received messages (e.g., underutilization or low energy efficiency or warning message from its LTM cells or measurement status report from UEs, or LTM Cell Deactivation Request or LTM Candidate Activation Request with a deactivation_flag from its LTM cells or UEs). The serving DU may then perform one or more actions to deactivate the subset of its active cells. For example, the serving DU may transmit a message (e.g., a Cell Activation Request with a deactivation_flag or Cell Deactivation Request message) to its active LTM candidate cells to initiate the deactivation. The message may include a list of active cells to be deactivated (e.g., a deactivate_cell_list). Optionally, the active LTM candidate cells may respond with a Cell Activation Response message with deactivation_flag or a Cell Deactivation Response to accept or reject the deactivation request. Accordingly, the active LTM candidate cells may conduct the deactivation. The deactivated LTM cells may indicate the deactivation completion (e.g., with a Cell Activation Complete/Failure message with a deactivation_flag or a Cell Deactivation Complete or Cell Deactivation Failure message). Furthermore, the Serving DU may indicate the deactivated cells to the Serving CU (e.g., with a deactivate_cell_list).

In some cases, the serving CU may decide to deactivate the serving LTM DU/cell (e.g., due to underutilization, low power efficiency, poor UE connections, or the like). In such cases, as indicated at 8, the Serving CU may transmit a request to the serving LTM DU/cell (e.g., a DU/Cell Activation Request with a deactivation_flag or a DU/Cell Deactivation Request message). Optionally, as indicated at 9, the serving LTM DU/cell may respond (e.g., with a DU/Cell Activation Response with a deactivation_flag or with a DU/Cell Deactivation Response message) to accept or reject the deactivation.

The serving CU may then notify the UE of the update to the inactive LTM candidate cells (e.g., for both intra-CU and intra-DU cases).

For example, as indicated at 10, the serving CU may transmit an RRC reconfiguration (e.g., add to the LTM_cell_inactive_list and remove from the LTM_cell_active_list) or deactivation MAC CE/DCI to the UE for updated LTM configurations (e.g., updated LTM_cell_active_list and LTM_cell_inactive_list). As indicated at 11, the UE may then report L1/L2 measurements to the serving LTM DU/cell based on the updated inactive LTM candidate DUs/Cells (e.g., LTM_cell_inactive_list) or L3 measurements to the serving CU.

In the case that the serving LTM DU/cell is deactivated, a cell switch may be performed to move the UE to another serving cell. For example, as illustrated at 12, the serving LTM DU/cell may transmit an LTM cell switch command (e.g., to a new serving cell based on the UE's L1 measurement) or an LTM conditional handover mode is indicated to offload the UE to another serving cell.

After the cell switch, the serving LTM DU/cell may conduct the deactivation, as illustrated at 13, and indicate completion of the deactivation, as illustrated at 14. For example, the LTM candidate DU/cell may indicate the completion of the deactivation via a DU/Cell Activation Complete (e.g., with a deactivation_flag) or via a DU/Cell Deactivation Complete (or DU/Cell Activation/Deactivation Failure) message.

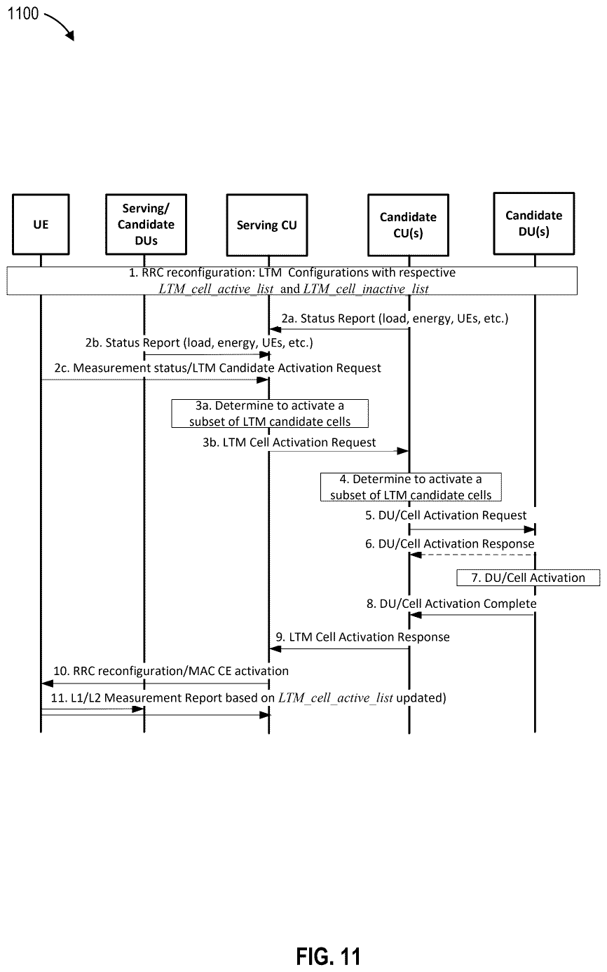

In some cases, a serving CU may configure the UE with one or more LTM candidate cells under management of one or more other CUs (referred to as candidate CUs). Call flow diagram 1100 of FIG. 11 depicts an example of “inter-CU” dynamic LTM candidate cell activation of LTM candidate cells under management of one or more candidate CU(s).

From the perspective of the serving CU, inter-CU cell activation/deactivation may be somewhat simpler because the serving CU just informs the candidate CU(s) that perform initiate the activation/deactivation for the LTM candidate cells under their management.

As illustrated at 1, the UE may be configured with LTM configurations of active LTM candidate cells (associated with LTM_cell_active_list) and inactive LTM candidate cells (associated with LTM_cell_inactive_list), as described for the intra-CU cases of FIGS. 9 and 10. As illustrated at 2b and 2c, the serving/candidate DUs and/or UE may send Measurement Status or LTM Candidate Activation Request messages to the serving CU(s) (as described for intra-CU activation cases), as described for the intra-CU cases of FIGS. 9 and 10.

For the inter-CU case, as illustrated at 2a, the Candidate CUs may also send a status report to the serving CU. For example, the candidate CUs may send a Resource Status Reporting message indicating information such as load, energy, overloaded/unsatisfied UEs, as described for the intra-CU cases of FIGS. 9 and 10.

As illustrated at 3a, the Serving CU may determine to activate a subset of inactive LTM candidate cells managed by one or more Candidate CUs based at least on the received message(s). The determination may be made, for example, for offloading or enhancing coverage as described for intra-CU activation cases. The Serving CU may transmit a message to the Candidate CU(s) to perform the activation. For example, as illustrated at 3b, the serving CU may send the candidate CU(s) an LTM Cell Activation Request message (e.g., with an activate_DU/cell_list).

Similarly, as indicated at 4, the Candidate CU(s) may determine to activate a subset of its inactive LTM candidate cells (e.g. for offloading or enhancing coverage as described for the intra-CU activation cases).

The serving CU(s) may perform operations (5-8), in a same or similar manner as described for the intra-CU activation cases, to activate the inactive LTM candidate cells under their management (based on the determination at 3a or the determination at 4).

For example, as illustrated at 5, the Candidate CU(s) may transmit to Candidate DUs/cells a DU/Cell Activation Request message to initiate the activation. As illustrated at 6, the Candidate DU/cells may respond with a DU/Cell Activation Response message to accept or reject the activation request. As illustrated at 7, the Candidate DU/cells may conduct the activation accordingly. As illustrated at 8, the Candidate DU/cells may indicate the completion with DU/Cell Activation Complete or DU/Cell Failure message.

The candidate CU(s) may transmit a message to the serving CU(s) to the Serving CU to indicate the status. For example, as indicated at 9, the candidate CU(s) may send the serving CU(s) an LTM Cell Activation Response message with an updated activate_DU/cell_list and/or deactivate_DU/cell_list.

As indicated at 10, the Serving CU may transmit RRC reconfiguration or activation MAC CE/DCI to the UE with for updated LTM configurations (e.g., updated LTM_cell_active_list and LTM_cell_inactive_list). As indicated at 11, the UE may report L1/L2 measurements to the serving LTM DU/cell per the updated active LTM candidate DUs/Cells (e.g., LTM_cell_active_list) or L3 measurements to the serving CU.

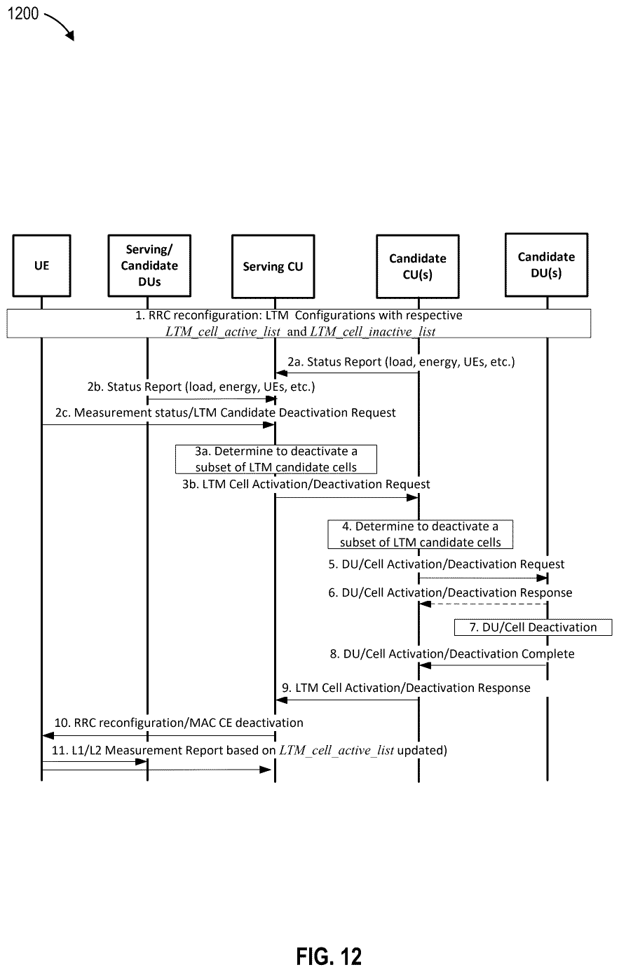

Referring next to call flow diagram 1200 of FIG. 12, an example of dynamic LTM candidate cell deactivation for the inter-CU scenario is shown. The example assumes deactivation of LTM candidate cells under management of one or more candidate CU(s).

As illustrated, steps 1-2c may be performed in a same or similar manner, as described above with reference to FIG. 11, providing the serving CU(s) with information for making LTM candidate deactivation decisions.

As illustrated at 3a, the Serving CU may determine to deactivate a subset of inactive LTM candidate cells managed by one or more Candidate CUs based at least on the received message(s). The determination may be made, for example, for saving energy with reduced active LTM candidate DUs/Cells, as described for intra-CU deactivation cases.

The Serving CU may transmit a message to the Candidate CU(s) to perform the deactivation. For example, as illustrated at 3b, the serving CU may send the candidate CU(s) an LTM Cell Activation Request message (e.g., with a deactivation_flag) or an LTM Cell Deactivation Request message, with a deactivate_DU/cell_list included.

Similarly, as indicated at 4, the Candidate CU(s) may determine to deactivate a subset of its inactive LTM candidate cells (e.g. for energy savings) as described for the intra-CU activation cases). The serving CU(s) may perform operations (5-8), in a same or similar manner as described for the intra-CU activation cases, to deactivate the inactive LTM candidate cells under their management (e.g., based on the determination at 3a or the determination at 4).

For example, as illustrated at 5, the Candidate CU(s) may transmit to Candidate DUs/cells a DU/Cell Activation Request message (e.g., with a deactivation_flag) or a DU/Cell Cell Deactivation Request message, with a deactivate_DU/cell_list, to initiate the deactivation. As illustrated at 6, the Candidate DU/cells may respond with a DU/Cell Activation Response message (e.g., with a deactivation_flag) or a DU/Cell Dectivation Response message to accept or reject the deactivation request. As illustrated at 7, the Candidate DU/cells may conduct the deactivation accordingly. As illustrated at 8, the Candidate DU/cells may indicate the completion with a DU/Cell Activation Complete message (e.g., with a deactivation_flag) or DU/Cell Deactivation Complete or DU/Cell Failure message.

The candidate CU(s) may transmit a message to the serving CU(s) to the Serving CU to indicate the deactivation status. For example, as indicated at 9, the candidate CU(s) may send the serving CU(s) an LTM Cell Activation Response message (e.g., with a deactivation_flag) or Deactivation Response message, with an updated activate_DU/cell_list and/or deactivate_DU/cell_list.

As indicated at 10, the Serving CU may transmit RRC reconfiguration or activation MAC CE/DCI to the UE with for updated LTM configurations (e.g., updated LTM_cell_active_list and LTM_cell_inactive_list). As indicated at 11, the UE may report L1/L2 measurements to the serving LTM DU/cell or L3 measurements to the serving CU per the updated active LTM candidate DUs/Cells (e.g., LTM_cell_active_list).

### Aspects Related to LTM With SSB Adaptation

As noted above, LTM candidate cells are typically statically or semi-statically configured, wherein the LTM candidate cells may be expected to be fully active, transmitting synchronization signal blocks (SSBs) for LTM measurements, LTM pre-synchronization and LTM cell switches. Giving different traffic loading at different times and locations, some LTM candidate cells operating in an always-on state may be underutilized, which wastes energy.

Aspects of the present disclosure, provide signaling mechanisms that may support adaptation of SSB transmissions in LTM candidate cells. In this context, adaptation of SSB transmissions may include changing periodicity (or density) of SSB transmissions (e.g., relative to a current periodicity for a given cell) or enabling on-demand SSB transmissions (e.g., assuming limited or no SSB transmissions in a given cell). The mechanisms provided herein may allow for network energy savings by adapting SSB transmissions in candidate cells based on certain criteria, such as changes in traffic loading, energy consumption, and channel conditions.

Aspects of the present disclosure also provide signaling mechanisms that may support dynamic activation and deactivation of LTM candidate cells. For example, the mechanisms may allow for network energy savings by activating or deactivating LTM candidate cells based on certain criteria, such as changes in traffic loading, energy consumption, and channel conditions.

In some cases, inactive and active LTM candidate cells may differ in whether or how they transmit SSBs, which may impact their visibility and behaviour. For example, if an inactive LTM candidate cell does not transmit any SSB, the LTM candidate cell cannot be observed or measured by a UE. As a result, that inactive LTM candidate cell may not be considered for LTM. According to aspects of the present disclosure, on-demand SSB may be activated for the inactive candidate cell for L1/L2 measurements, and the like

If an inactive LTM candidate cell transmits limited or sparse SSB (always-on SSB), the LTM candidate cell can be observed or measured by a UE. Based on the UE's LTM measurement report, the inactive LTM candidate cell can be selected for LTM. However, with only sparsely transmitted SSBs, it may take a longer time for the UE to collect LTM measurements, as well as to perform an LTM procedure. According to aspects of the present disclosure, additional on-demand SSB transmission may be activated or the sparse SSB transmissions may be adapted to address the latency issue.

If an active LTM candidate cell transmits partial or full sets of SSBs, the LTM candidate cell can be observed or measured by a UE. Based on the UE's LTM measurement report, the active LTM candidate cell can be selected for LTM. However, partially or fully transmitted SSBs may not be optimized for a UE to conduct fast LTM measurements for an LTM procedure. Aspects of the present disclosure may adapt SSB transmissions (e.g., activating on-demand SSB transmissions or increasing the density of SSB transmissions) to address this latency issue.

In one example of SSB adaptation, an inactive LTM candidate cell may be indicated to transmit on-demand SSB (OD-SSB) or to adapt SSB periodicity for fast L1 measurements, and then the inactive LTM candidate cell may be activated based on the fast L1 measurement report. With this approach, the inactive LTM candidate cell may benefit most with energy saving before being activated.

In another example of SSB adaptation, an active LTM candidate cell may be deactivated for energy saving, where on-demand SSB (OD-SSB) transmissions may be deactivated or the SSB periodicity may be (further) adapted for more energy saving

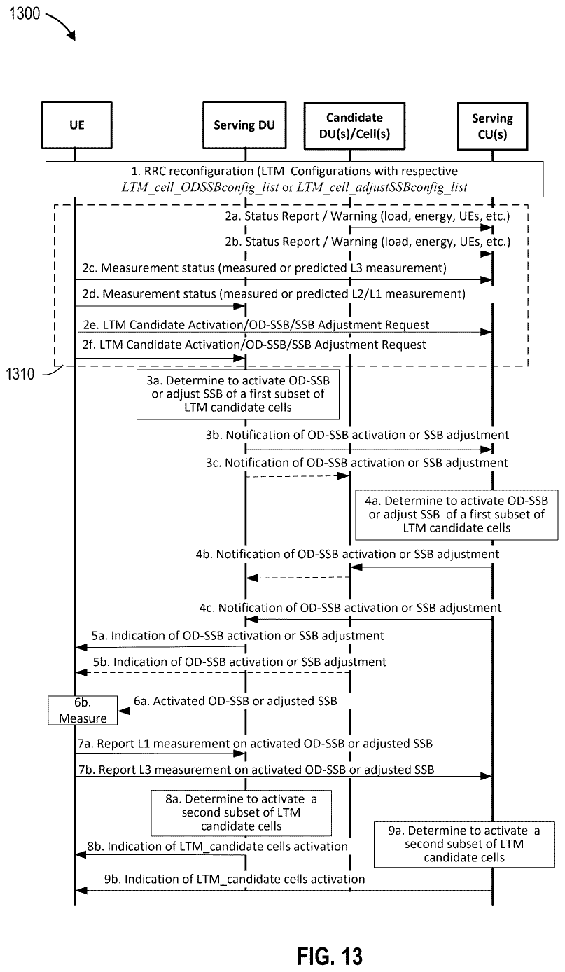

LTM with SSB adaptation proposed herein may be understood with reference to the call flow diagrams of FIGS. 13-16. In some aspects, the UE shown in FIGS. 13-16 may be an example of the UE 104 depicted and described with respect to FIGS. 1 and 3. In some aspects, the (serving and candidate) CUs and (serving and candidate) DUs shown in FIGS. 13-16 may be examples the CU 210 and DU 230 depicted and described with respect to FIG. 2.

Referring first to call flow diagram 1300 of FIG. 13, an example of LTM with SSB adaptation for LTM candidate cell activation. The illustrated example assumes LTM with SSB adaptation for LTM candidate cells (with DUs) under management of a serving CU (or one of the serving CUs in the case of shared DUs).

As illustrated at step 1, the UE may be configured with LTM configurations. The LTM configurations may include LTM configurations of active LTM candidate cells which may be identified in a list (e.g., LTM_cell_active_list). These LTM candidate cells may be default active cells (e.g., always on) for coverage distribution or for network load distribution. These active LTM candidate cells may be configured with one or more SSB configurations (e.g., LTM_cell_SSBconfig_list), which may include one or more on-demand (OD) SSB configurations for an LTM candidate cell (e.g., with an LTM_cell_ODSSBconfig_list) or SSB adjustment configurations for an LTM candidate cell (e.g., with an LTM_cell_adjustSSBconfig_list).

The LTM configurations may also include LTM configurations of inactive LTM candidate cells (associated with LTM_cell_inactive_list). Inactive LTM candidate cells may be default inactive cells (i.e., “on demand” as configured), for example, for coverage enhancement or offloading traffic or candidate cells that have not been activated yet via LTM cell activation procedure). Inactive LTM candidate cells may also be configured with one or more SSB configurations (e.g., LTM_cell_SSBconfig_list), which may include one or more on-demand (OD) SSB configurations for an LTM candidate cell (e.g., with an LTM_cell_ODSSBconfig_list) or SSB adjustment configurations for an LTM candidate cell (e.g., with an LTM_cell_adjustSSBconfig_list). Among LTM candidate cells initially configured as inactive, some may be activated already via the activation procedure (e.g., described below) and others may be not activated yet and may be activated at a later time.

As indicated at 1310, via steps 2a-2f, the Serving CU and/or serving DU may receive various types of information that can be used for determine whether to activate one or more of the configured LTM candidate cells based on the measurements with SSB adaptation.

As illustrated (at 2a/2b), the information may come from LTM candidate DUs or the serving DU. In this context, LTM candidate DUs may refer to an active LTM candidate DUs/Cells, which may be serving DU/Cells for other UEs already or inactive LTM candidate DUs/Cells with sparse or no SSB transmissions, while a Serving DU may refer to a DU serving the UE currently. Such DUs may send a Status Report message (e.g., Resource Status Response message for one time response or Resource Status Update message for periodic response), for example, based on the Serving CU's Status Request (e.g., Resource Status Request message).

The status report may include various information regarding the DUs/Cells'status that may be useful for activating inactive LTM candidate DUs/Cells for various purposes (e.g., for offloading or enhancing coverage with additional activated LTM candidate DUs/Cells). Such information may include, for example, an indication of resource overloading, energy overconsumption, overload of UEs, or unsatisfied UEs. Resource overloading may indicate, for example, a hardware/processing load above a threshold (e.g., at least a first threshold associated threshold_Process_High with one or more activate LTM candidate cells with LTM_cell_active_list), an uplink or downlink load above a threshold (e.g., at least a second threshold threshold_UL_High or threshold_DL_High associated with one or more activate LTM candidate cells with LTM_cell_active_list), or percentage of resource (e.g., physical resource block (PRB)) utilization above a threshold (e.g., at least a third threshold associated threshold_Resource_High with one or more activate LTM candidate cells with LTM_cell_active_list). Energy overconsumption may indicate energy/power consumption above a threshold or energy/power consumption percentage above a threshold (e.g., at least a fourth threshold threshold_Energy_High or EnergyPercent_High associated with one or more activate LTM candidate cells with LTM_cell_active_list). Overload of UEs may indicate, for example, a number of active UEs (e.g., UEs with good connections for UL or DL communications) with measurements above a threshold (e.g., at least a fifth threshold threshold_UEconnect_High associated with one or more activate LTM candidate cells with LTM_cell_active_list). Unsatisfied UEs (e.g., UEs with poor connections) may indicate, for example, a number of UEs with measurements below a threshold (e.g., at least a sixth threshold threshold_UEconnect_Low associated with one or more activate LTM candidate cells with LTM_cell_active_list).

In some aspects, LTM candidate DUs or the serving DU may initiate one or more transmissions of a Status Report message, for example, based on one or more thresholds (e.g., a set of thresholds corresponding respectively to hardware/processing load, uplink or downlink load, percentage of resource utilization, energy consumption, UEs with good connections, UEs with poor connections, or the like).

Additionally, or alternatively, according to certain aspects, LTM candidate DUs or the Serving DU may send a status warning message to the Serving CU (e.g., via/as a DU Status Indication message) indicating an overload (e.g., process load or UL/DL load above a threshold (e.g., for a normal operation)) or energy overconsumption (e.g., energy consumption above a threshold or percentage of energy above a threshold (e.g., as budgeted for network energy saving)) or too many UEs to support (e.g., number of connected UEs above a threshold (e.g., to ensure the QoS of communication)) or too many UEs need to switch cells for better connections (e.g., UE experience with a service).

As illustrated (at 2c/2d), the UE may send various types of information that may allow for enhancing coverage with additional active LTM candidate DUs/Cells. For example, such information may be conveyed via a measurement status message to the Serving CU/DU (e.g., a UE Assistance Information message or L3/L2/L1 report message). Such a message may include the measured or predicted results that do not satisfy conditions expected to maintain a reliable connection or user experience of a service with the current Serving DU/Cell. For example, the results may include one or more highest L3/L2/L1 measurements (measured or predicted) that may be expected to trigger a radio link failure (RLF) in the near future with the Serving DU/Cell (e.g., near a threshold for triggering RLF). The report may also include measured or predicted results not satisfying conditions to select an LTM candidate cell for cell switching, such as one or more highest L3/L2/L1 measurements (measured or predicted) that may not meet the requirement of cell (re)selection (e.g., below a threshold for cell selection) with LTM candidate cells (e.g., need LTM candidate cells with better connection).

As illustrated (at 2e/2f), in some cases, the UE may send a request (e.g., an LTM Candidate Activation Request) for activating inactive LTM candidate cells (e.g., based on the measurement status (e.g., need LTM candidate cells with better connection) or a request for SSB adaptation (e.g., OD-SSB Activation Request or SSB Adjustment Request) (e.g., for efficient L1/L2 measurement). Such a request may be sent, for example, to the serving CU(s), via an RRC message, or to the Serving DU, via a MAC CE, UCI or an Uplink-Wakeup Signal (UL-WUS) or similar type of signal (e.g., with an implicit indication (e.g., based on the signal configuration) or explicit indication (e.g., included in the signal) for cell activation or SSB adaptation). While the activation request is shown as coming from the UE, similar requests could also come from the serving DU/cell or candidate DU/cell(s), for example, based on the status of load, energy, UEs, or the like. Additionally, or alternatively, the request for SSB adaptation activation may be transmitted with SSB Adaptation Activation Request message which may include indication of OD-SSB activation and or SSB adjustment.

Based on the information obtained via steps 2a-2f, SSB adaptation may be determined by the serving DU (as shown at steps 3a-3c for the intra-DU case) or by the serving CU (as shown in the inter-DU case of steps 4a-4c).

As illustrated (at 3a), for the intra-DU case, the serving DU may determine to perform SSB adaptation based at least on the received message(s) from the UE(s) and/or the loading and energy status or warning or request from its LTM candidate cells. For example, the serving DU may decide activate OD-SSB transmissions (e.g., additional SSB transmissions at the same or different frequency allocations (e.g., in time domain and/or in frequency domain) with the same or different beam directions (e.g., in spatial domain)) of a first subset of its inactive LTM candidate cells (e.g., for LTM cell activation with a LTM_cell_toactivate_list) or to adjust SSB transmissions (e.g., a shorter period for more frequent transmissions at same or different frequency allocations (e.g., adjustment in time domain and/or in frequency domain) or more beam directions (e.g., adjustment in spatial domain)) of a first subset of its inactive LTM candidate cells (e.g., for LTM cell activation with a LTM_cell_toactivate_list) with SSB transmissions more frequently or with finer granularity.

As illustrated at 3b and 3c, the serving DU may notify the Serving CU (at 3b) or its LTM candidate cells (at 3c) with a Notification of OD-SSB activation or with a Notification of SSB adjustment. Such notifications may include OD-SSB parameters (e.g., period(s), number of transmissions, time allocation(s) or timeline(s), frequency allocation(s), beam index(es) or QCL/TCI state(s) or spatial filter(s)) based on a selected configuration from the LTM_cell_ODSSBconfig_list of each cell of the first subset of LTM candidate cells (e.g., for LTM cell activation with a LTM_cell_toactivate_list) or SSB-adjustment parameters (e.g., period(s), number of transmissions, time allocation(s) or timeline(s), frequency allocation(s), beam index(es) or QCL/TCI state(s) or spatial filter(s)) based on a selected configuration from the LTM_cell_adjustSSB_list of each of the first subset of LTM candidate cells (e.g., for LTM cell activation with a LTM_cell_toactivate_list).

As illustrated at 4a, for the inter-DU case (or intra-CU case), the Serving CU may determine to perform SSB adaptation, based at least on the received messages (e.g., at least one of the messages from steps 2a-2f). For example, the serving CU may activate OD-SSB transmissions of a first subset of its inactive LTM candidate cells (e.g., for LTM cell activation with a LTM_cell_toactivate_list) or to adjust SSB transmissions (e.g., a shorter period for more frequent transmissions at same or different frequency allocations (e.g., adjustment in time domain and/or in frequency domain) or more beam directions (e.g., adjustment in spatial domain)) of a first subset of its inactive LTM candidate cells (e.g., for LTM cell activation with a LTM_cell_toactivate_list).

As illustrated at 4b, the serving CU may notify the LTM candidate DUs/cells with a Notification of OD-SSB activation (e.g., including the OD-SSB parameters (e.g., period(s), number of transmissions, time allocation(s) or timeline(s), frequency allocation(s), beam index(es) or QCL/TCI state(s) or spatial filter(s)) based on a selected configuration from the LTM_cell_ODSSBconfig_list of each cell of LTM_cell_toactivate_list) or with a Notification of SSB adjustment (e.g., including the SSB-adjustment parameters (e.g., period(s), number of transmissions, time allocation(s) or timeline(s), frequency allocation(s), beam index(es) or QCL/TCI state(s) or spatial filter(s)) based on a selected configuration from the LTM_cell_adjustSSB_list of each cell of LTM_cell_toactivate_list). In some cases, the LTM candidate DUs/cells may further forward the received Notification of OD-SSB activation or Notification of SSB adjustment to their Serving DU.

As illustrated at 4c, the serving CU may also notify the serving DU. For example, the serving CU may notify the serving DU via a Notification of OD-SSB activation (e.g., including the OD-SSB parameters (e.g., period(s), number of transmissions, time allocation(s) or timeline(s), frequency allocation(s), beam index(es) or QCL/TCI state(s) or spatial filter(s)) based on a selected configuration from the LTM_cell_ODSSBconfig_list of each cell of LTM_cell_toactivate_list) or via a Notification of SSB adjustment (e.g., including the SSB-adjustment parameters (e.g., period(s), number of transmissions, time allocation(s) or timeline(s), frequency allocation(s), beam index(es) or QCL/TCI state(s) or spatial filter(s)) based on a selected configuration from the LTM_cell_adjustSSB_list of each cell of LTM_cell_toactivate_list).

The DUs (e.g., the Serving DU at step 5a and/or Candidate DUs at step 5b) may inform the UE of the activated SSB adaptation configurations. For example, the DUs may transmit an Indication of OD-SSB transmissions (e.g., MAC CE or DCI with the period, center frequency, beam or TCI state and/or a number of OD-SSB transmissions (e.g., for implicit termination of the transmission)) or an Indication of SSB Adjustment. (e.g., MAC CE or DCI with the period, center frequency, beam or TCI state and/or a number of SSB adaptation transmissions (e.g., implicit termination of the adjustment)).

As indicated at 6b, the UE may conduct L1/L2/L3 measurements with activated OD-SSB transmissions or adjusted SSB transmissions based on the indication received. As indicated at 7a, the UE may report the L1/L2 measurements of activated OD-SSB or adjusted SSB to the Serving LTM DU or, as indicated at 7b, the UE may report the L3 measurements to the Serving LTM CU(s).

As illustrated at 8a (for the intra-DU case), the serving DU may accordingly determine to activate a second subset (e.g., a subset of the first subset LTM_cell_toactivate_list determined at 3a) of its inactive LTM candidate cells. As illustrated at 8b, the serving DU may then notify the UE of the LTM candidate cell activation (e.g., activation indicated with MAC CE or DCI).

Similarly, as illustrated at 9a (for the inter-DU case), the serving CU may accordingly determine to activate a second subset (e.g., a subset of the first subset LTM_cell_toactivate_list determined at 4a) of its inactive LTM candidate cells. As illustrated at 9b, the serving CU may then notify the UE of the LTM candidate cell activation (e.g., RRC reconfiguration with updated active LTM candidate cells, or activation indicated with MAC CE or DCI).

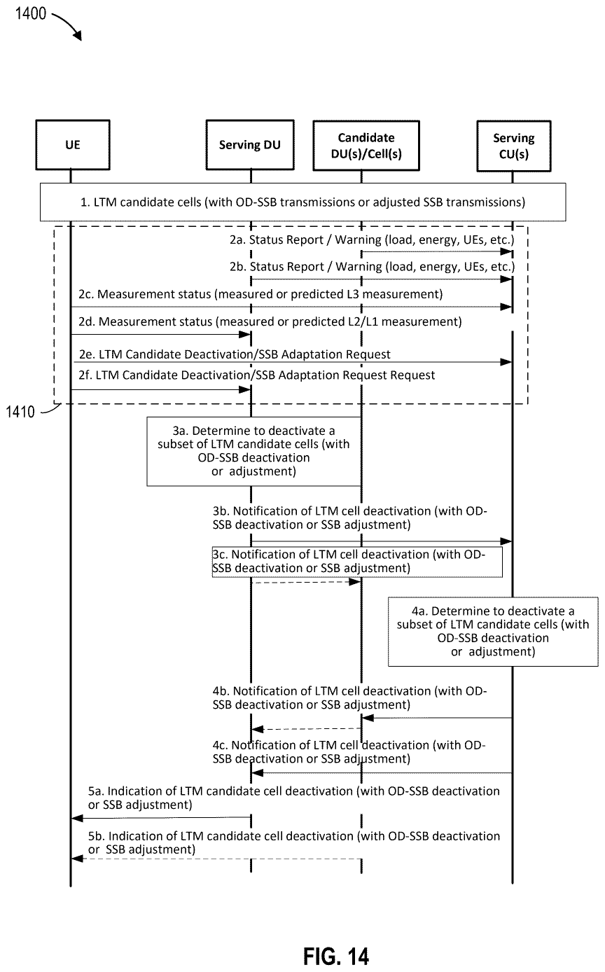

Referring next to call flow diagram 1400 of FIG. 14, an example of LTM with SSB adaptation for LTM candidate cell deactivation. The illustrated example assumes deactivation of LTM candidate cells under management of the serving CU(s).

As indicated at 1410, via steps 2a-2f, the Serving CU and/or serving DU may receive various types of information that can be used for determine whether to deactivate one or more of the configured LTM candidate cells with SSB adaptation.

As illustrated at 1, the UE may be configured with LTM configurations of active LTM candidate cells (associated with LTM_cell_active_list) and inactive LTM candidate cells (associated with LTM_cell_inactive_list) where the active and inactive LTM candidate cells may be configured with one or more OD-SSB configurations (e.g., with an LTM_cell_ODSSBconfig_list) and/or SSB adjust configurations (e.g., LTM_cell_adjustSSBconfig_list), as described for the intra-CU cases of FIG. 9. Additionally, LTM candidate cells may transmit SSBs based on SSB adaptation (e.g., including OD-SSB transmissions and/or Adjusted SSB transmissions). Steps 2a-2f may be performed in a same or similar manner, as described above with reference to FIG. 9, providing the serving CU(s) with information for making LTM candidate deactivation decisions (e.g., system underutilization, energy inefficiency, poor UE experience, or the like). The illustrated example assumes LTM with SSB adaptation for LTM candidate cells (with DUs) under management of a serving CU (or one of the serving CUs in the case of shared DUs).

For example, the status report may include various types of information regarding the DUs/Cells'status that may be useful for deactivating the active LTM candidate DUs/Cells for more energy saving. Such information may include, for example, an indication of system underutilization, energy inefficiency, or THE like. System underutilization may indicate, for example, a hardware/processing load below a threshold (e.g., at least a first threshold associated threshold_Process_Low with one or more activate LTM candidate cells of the LTM_cell_active_list) or an uplink or downlink load below a threshold (e.g., at least a second threshold threshold_UL_Low or threshold_DL_Low associated with one or more activate LTM candidate cells of the LTM_cell_active_list) or a resource (e.g., PRB) utilization below a threshold (e.g., at least a third threshold threshold_resource_Low associated with one or more activate LTM candidate cells of the LTM_cell_active_list). Energy inefficiency may indicate average energy/power consumption (e.g., per operation or per service or per UE) above a threshold or average energy/power consumption percentage (e.g., per operation or per service or per UE) above a threshold (e.g., at least a fourth threshold threshold_Energy_Average associated with one or more activate LTM candidate cells of the LTM_cell_active_list). Connection of UEs may indicate, for example, a number of UEs with good connections for UL or DL communications below a threshold or the number of UEs with poor connections for UL or DL communications above a threshold (e.g., at least a sixth threshold threshold_UE_GoodConnect_Low or threshold_UE_PoorConnect_High associated with one or more activate LTM candidate cells of the LTM_cell_active_list).

In some aspects, LTM candidate DUs or the serving DU may initiate one or more transmissions of a Status Report message, for example, based on one or more thresholds (e.g., a set of thresholds corresponding respectively to system underutilization, uplink or downlink or resource underutilization, energy inefficiency, low UE experiences of the services (e.g., low number of UEs with good connections or high number of UEs with poor connections, or the like).

Furthermore, according to certain aspects, LTM candidate DUs or the Serving DU may send a status warning message to the Serving CU (e.g., via/as a DU Status Indication message) indicating a status warning such as an underutilization (e.g., process load or UL/DL or resource utilization below a threshold (e.g., for a normal operation)) or energy inefficiency (e.g., average energy consumption above a threshold or average percentage of energy above a threshold (e.g., as budgeted for network energy saving)) or too many UEs with poor connections (e.g., number of connected UEs with good connections below a threshold (e.g., meeting QoS requirements) and number of connected UEs with poor connections above a threshold (e.g., missing QoS requirements)).

The UE may send various messages, for example, for saving energy with reduced active LTM candidate DUs/Cells. For example, as illustrated at 2c and 2d, the UE may send a Measurement Status to the Serving CU/DU (e.g., UE Assistance Information message or L3/L2/L1 report message with the measured or predicted results not satisfying to maintain a reliable connection or user experience of a service with the current Serving DU/Cell (e.g., one or more highest L3/L2/L1 measurements (measured or predicted) may trigger a radio link failure (RLF) in near future with the Serving DU/Cell) and with the measured or predicted results not satisfying to select a LTM candidate cell for cell switching (e.g., one or more highest L3/L2/L1 measurements (measured or predicted) may not meet the requirement of cell (re)selection with LTM candidate cells).

As illustrated at 2e and 2f, the UE may send an LTM Candidate Deactivation Request for deactivating active LTM candidate cells and/or an LTM Candidate Deactivation Request or OD-SSB Deactivation Request or SSB Adjustment Request for requesting LTM candidate cells to stop transmitting OD-SSB or to further adjust SSB transmissions (e.g., stop SSB transmission or adjust SSB transmissions with a longer period at the same or different frequency allocations with same or reduced beams or TCI states) for less frequent or coarse granularity transmissions. Such requests may be sent to the Serving CU(s) with RRC message or to the Serving DU with MAC CE, UCI or an UL-WUS like signal, for example, based on the status of underutilization, low energy efficiency, UEs with poor connections, or the like. Additionally, or alternatively, the request for SSB adaptation deactivation may be transmitted with SSB Adaptation Deactivation Request message which may include indication of OD-SSB deactivation and or SSB adjustment deactivation or readjustment.

Based on the information obtained via steps 2a-2f, deactivation of one or more candidate cells with SSB adaptation may be determined by the serving DU (as shown at steps 3a-3c for the intra-DU case) or by the serving CU (as shown in the inter-DU case of steps 4a-4c).

As illustrated (at 3a), for the intra-DU case, to save energy, the Serving DU may determine to deactivate a subset of its active LTM candidate cells (e.g., LTM_cell_todeactivate_list) with OD-SSB Deactivation and/or SSB Adjustment (e.g., stop SSB transmission or adjust SSB transmissions with a longer period, fewer frequency allocations, or reduced beams or TCI states for less frequent or coarse granularity transmissions), based at least on the received message(s) from the UE(s) and/or the loading and energy status of its LTM candidate cells.

As illustrated (at 3b and 3c), the serving DU may notify the serving CU (e.g., at step 3b) or its LTM candidate cells (e.g., at step 3c) via a Notification of LTM Cell Deactivation (e.g., with LTM_cell_todeactivate_list). Additionally, the Notification of LTM Cell Deactivation may also include an OD-SSB Deactivation indications (e.g., with the OD-SSB deactivation indication or flag set for each cell of LTM_cell_todeactivate_list to be deactivated) or SSB Adjustment parameters (e.g., with a longer period, fewer frequency allocations, or reduced beams or TCI states for less frequent transmissions) based on a selected configuration from the LTM_cell_adjustSSBconfig_list for each cell of LTM_cell_todeactivate_list to be deactivated.

As illustrated at 4a, for the inter-DU case, to save energy, the serving CU may decide to deactivate a subset of its active LTM candidate cells (e.g., LTM_cell_todeactivate_list) with OD-SSB Deactivation or SSB Adaptation (e.g., stop SSB transmission or adjust SSB transmissions with a longer period, fewer frequency allocations, or reduced beams or TCI states for less frequent or coarse granularity transmissions), based on the received messages (e.g., at least one of the messages from steps 2a-2f).

As illustrated at 4b, the serving CU may notify the LTM candidate DUs/cells with a Notification of LTM Cell Deactivation (e.g., with LTM_cell_todeactivate_list). Additionally, the notification may also include OD-SSB Deactivation indications (e.g., with the OD-SSB deactivation indication or flag set for each cell of LTM_cell_todeactivate_list to be deactivated) or SSB adjustment parameters (e.g., with a longer period, fewer frequency allocations, or reduced beams or TCI states for less frequent or coarse granularity transmissions), based on a selected configuration from the LTM_cell_adjustSSBconfig_list for each cell of LTM_cell_todeactivate_list to be deactivated. The LTM candidate DUs/cells may further forward to the Serving DU the received Notification of LTM Cell Deactivation.

As illustrated at 4c, the serving CU may also notify the Serving DU with a Notification of LTM Cell Deactivation (e.g., with LTM_cell_todeactivate_list). Additionally, the notification may also include OD-SSB Deactivation indications (e.g., with the OD-SSB deactivation indication or flag set for the cells of LTM_cell_todeactivate_list to be deactivated or SSB Adjustment parameters (e.g., stop SSB transmission or adjust SSB transmissions with a longer period, fewer frequency allocations, or reduced beams or TCI states for less frequent transmissions based on a selected configuration from the LTM_cell_adjustSSBconfig_list for each cell of LTM_cell_todeactivate_list to be deactivated).

The DUs (e.g., the Serving DU at step 5a and/or Candidate DUs at step 5b) may inform the UE of the LTM Cell Deactivation with SSB adaptation. For example, the DUs may transmit an Indication of LTM Cell Deactivation (e.g., with OD-SSB Deactivation or SSB Adjustment indicated for each cell of LTM_cell_todeactivate_list to be deactivated). This indication may be transmitted, for example, via a MAC CE or DCI with a bitmap or flag for OD-SSB Deactivation or with a larger period value or frequency allocation or beam/TCI state or configuration index/code point of LTM_cell_adjustSSBconfig_list for SSB Adjustment. Additionally, or alternatively, the Serving CU may also inform the UE of the LTM Cell Deactivation with SSB adaptation (e.g., RRC reconfiguration with active or inactive LTM candidate cells) or MAC CE or DCI indication.

In some aspects, the LTM cell deactivation may also be indicated with LTM cell activation with a deactivation flag indicated in the message (e.g., Notification of LTM cell activation message with deactivation indicated or flagged or Indication of LTM candidate cell activation message with deactivation indicated or flagged).

In some aspects, the indication of SSB adaptation (e.g., including OD-SSB termination or the indication of SSB adjustment) may be transmitted separately to the UE following the indication of LTM candidate cell deactivation.

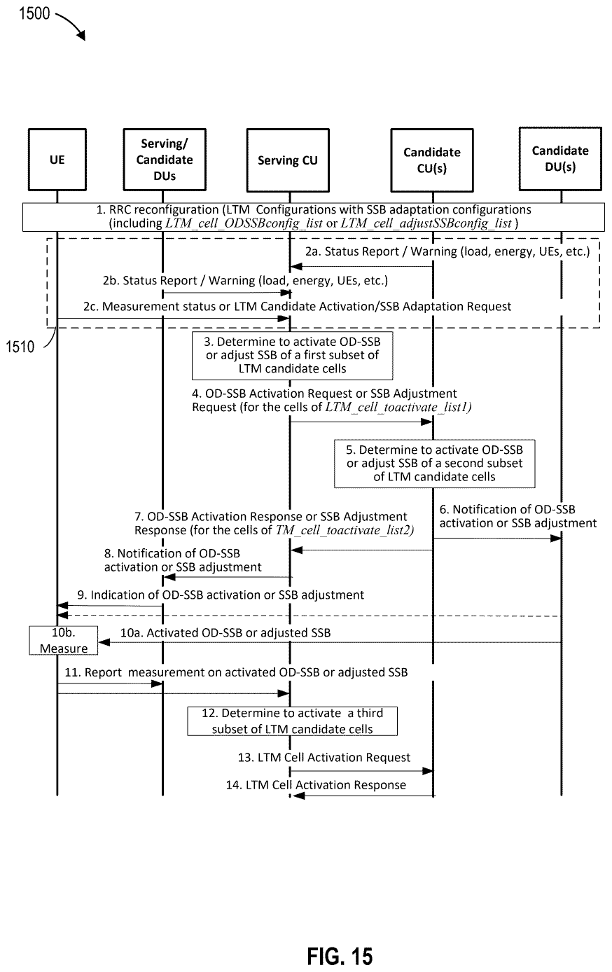

In some cases, a serving CU may configure the UE with one or more LTM candidate cells under management of one or more other CUs (referred to as candidate CUs). Call flow diagram 1500 of FIG. 15 depicts an example of “inter-CU” dynamic LTM candidate cell activation of LTM candidate cells under management of one or more candidate CU(s).

From the perspective of the serving CU, inter-CU cell LTM with SSB adaptation may be somewhat simpler because the serving CU just informs the candidate CU(s) that perform SSB adaptation for the LTM candidate cells'activation under their management.

As illustrated at 1, the UE may be configured with LTM configurations of active LTM candidate cells (associated with LTM_cell_active_list) and inactive LTM candidate cells (associated with LTM_cell_inactive_list) where the active and inactive LTM candidate cells may be configured with one or more SSB adaptation configurations which may include one or more OD-SSB configurations (e.g., including one or more OD-SSB configurations with an LTM_cell_ODSSBconfig_list) and/or one or more SSB adjustment configurations with LTM_cell_adjustSSBconfig_list), as described for the intra-CU cases of FIG. 9.

As indicated at 1510, via steps 2a-2c, the Serving CU may receive various types of information that can be used for determine whether to activate one or more of the configured LTM candidate cells (e.g., as described for the intra-CU cases of FIG. 13 with steps 2a-2f).

As illustrated at 2b and 2c, the serving/candidate DUs and/or UE may send Measurement Status or LTM Candidate Activation Request/SSB Adaptation request messages to the serving CU(s) (as described for intra-CU activation cases), as described for the intra-CU cases of FIG. 13.

For the inter-CU case, as illustrated at 2a, the Candidate CUs may also send a status report or status warning to the serving CU. For example, the candidate CUs may send a Resource Status Reporting or Status warning message indicating information such as load, energy, overloaded/unsatisfied UEs, as described for the intra-CU cases of FIG. 13.

As illustrated at 3, the Serving CU may determine to activate SSB adaption for one or more LTM candidate cells managed by one or more Candidate CUs based at least on the received message(s). The determination may be made, for example, to activate OD-SSB transmissions of a first subset of the Candidate CU(s)′ inactive LTM candidate cells (e.g., LTM_cell_toactivate_list1) or to adjust SSB transmissions (e.g., a shorter period in time domain or more frequency allocations in frequency domain or more beam or TCI states in spatial domain for more frequent or finer granularity transmissions) of a first subset of the Candidate CU(s)′ inactive LTM candidate cells (e.g., LTM_cell_toactivate_list1).

As indicated at 4, the serving CU may send to the candidate CU(s) with an OD-SSB Activation Request (e.g., including preferred OD-SSB parameters based on a selected configuration from the LTM_cell_ODSSBconfig_list of each cell of LTM_cell_toactivate_list1) or with an SSB Adjustment Request (e.g., including preferred SSB-adjustment parameters based on a selected configuration from the LTM_cell_adjustSSB_list of each cell of LTM_cell_toactivate_list1) as described in FIG. 9. Additionally, or alternatively, the request for SSB adaptation activation may be transmitted with SSB Adaptation Activation Request message which may include indications of OD-SSB activation and/or SSB adjustment (e.g., including the OD-SSB parameters and/or SSB adjustment parameters described in FIG. 13).

As illustrated at 5, based on the request from the Serving CU and other messages received from its Candidate DUs (e.g., similar to steps 2b and 2c), the Candidate CU(s) may determine to activate OD-SSB transmissions of a second subset of its inactive LTM candidate cells (e.g., LTM_cell_toactivate_list2) or to adjust SSB transmissions (e.g., a shorter period for more frequent transmissions) of a second subset of its inactive LTM candidate cells (e.g., LTM_cell_toactivate_list2).

As illustrated at 6, the Candidate CU(s) may notify its Candidate DU(s) with a Notification of OD-SSB activation (e.g., including the OD-SSB parameters based on a selected configuration from the LTM_cell_ODSSBconfig_list of each cell of LTM_cell_toactivate_list2) or with a Notification of SSB adjustment (e.g., including the SSB-adjustment parameters based on a selected configuration from the LTM_cell_adjusttSSB_list of each cell of LTM_cell_toactivate_list2) as described in FIG. 13. Additionally, or alternatively, the notification for SSB adaptation activation may be transmitted with Notification of SSB Adaptation Activation message which may include indications of OD-SSB activation and/or SSB adjustment (e.g., including the parameters described in FIG. 13).

As illustrated at 7, the candidate CU(s) may send the Serving CU an OD-SSB Activation Response (e.g., including OD-SSB parameters based on a selected configuration from the LTM_cell_ODSSBconfig_list of each cell of LTM_cell_toactivate_list2) or with an SSB Adjustment Response (e.g., including SSB-adaptation parameters based on a selected configuration from the LTM_cell_adjustSSB_list of each cell of LTM_cell_toactivate_list2). Additionally, or alternatively, the response to SSB adaptation activation may be transmitted with SSB Adaptation Activation Response message which may include indications of OD-SSB activation and/or SSB adjustment.

As illustrated at 8, the serving CU may notify its serving/candidate DU(s) with a Notification of OD-SSB activation (e.g., including the OD-SSB parameters based on a selected configuration from the LTM_cell_ODSSBconfig_list of each cell of LTM_cell_toactivate_list2) or with a Notification of SSB adjustment (e.g., including the SSB-adjustment parameters based on a selected configuration from the LTM_cell_adjusttSSB_list of each cell of LTM_cell_toactivate_list2). Additionally, or alternatively, the notification of SSB adaptation activation may be transmitted with Notification of SSB Adaptation Activation message which may include indications of OD-SSB activation and/or SSB adjustment.

As illustrated at 9, the DUs may transmit, to the UE, an indication of OD-SSB activation or an indication of SSB adaptation. Additionally, or alternatively, the indication of SSB adaptation activation may be transmitted with Indication of SSB Adaptation Activation message which may include indications of OD-SSB activation and/or SSB adjustment. As illustrated at 10b, the UE may conduct L1/L2/L3 measurements with activated OD-SSB transmissions or adjusted SSB transmissions based on the indication received.

As illustrated at 11, the UE may report the L1/L2 measurements of activated OD-SSB transmissions or adjusted SSB transmissions to the Serving LTM DU or the L3 measurements of OD-SSB to the Serving LTM CU(s).

As illustrated at 12, the Serving CU may accordingly determine to activate a third subset of inactive LTM candidate cells. As illustrated at 13, the Serving CU may transmit LTM Cell Activation Request to the Candidate CU(s). As illustrated at 14, the Candidate CU(s) may transmit LTM Cell Activation Response to the Serving CU.

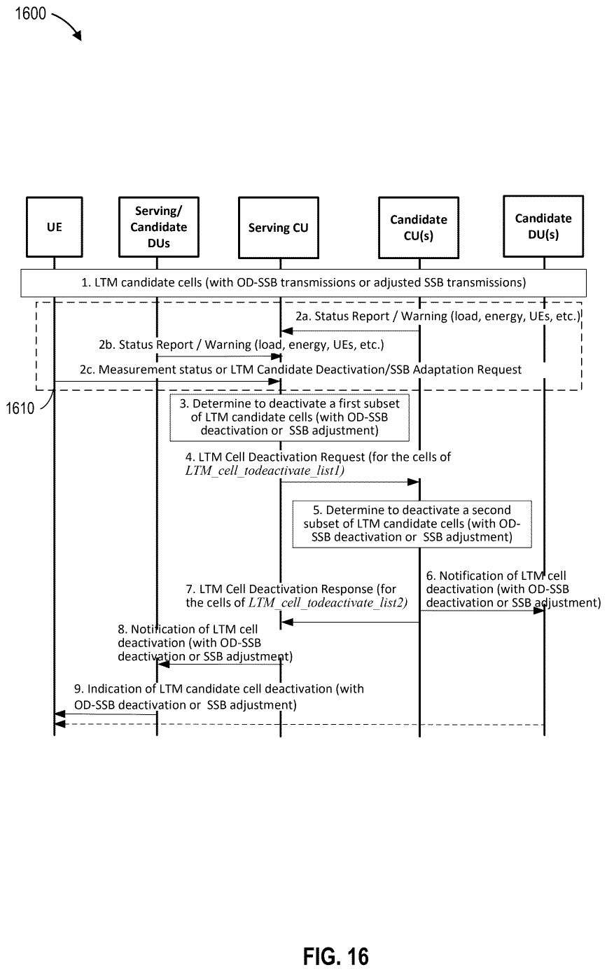

Referring next to call flow diagram 1600 of FIG. 16, an example of LTM cell deactivation with SSB adaptation for the inter-CU scenario is shown. The example assumes LTM candidate cells deactivation with SSB adaptation for under management of one or more candidate CU(s).

As illustrated at 1, the UE may be configured with LTM configurations of active LTM candidate cells (associated with LTM_cell_active_list) and inactive LTM candidate cells (associated with LTM_cell_inactive_list) where the active and inactive LTM candidate cells may be configured with one or more OD-SSB configurations (e.g., with an LTM_cell_ODSSBconfig_list) and/or SSB adjust configurations (e.g., LTM_cell_adjustSSBconfig_list), as described for the intra-CU cases of FIG. 13. Additionally, LTM candidate cells may transmit SSBs based on SSB adaptation (e.g., including OD-SSB transmissions and/or adjusted SSB transmissions). Steps 2a-2c may be performed in a same or similar manner, as described above with reference to FIG. 14 (e.g., steps 2a-2f), providing the serving CU(s) or the Candidate CU(s) with information for making LTM candidate deactivation decisions (e.g., system underutilization, energy inefficiency, poor UE experience, or the like).

As indicated at 1610, via steps 2a-2c, the Serving CU may receive various types of information that can be used for determine whether to deactivate one or more of the active LTM candidate cells. Steps 2a-2c may be performed in a same or similar manner, as described above with reference to FIG. 14 (e.g., steps 2a-2f).

As illustrated at 3, to save energy, the Serving CU may decide to deactivate a first subset of the Candidate CU(s)′ active LTM candidate cells (e.g., LTM_cell_todeactivate_list1) with OD-SSB deactivation or SSB adjustment (e.g., a longer period for less frequent transmissions).

As indicated at 4, the serving CU may send to the Candidate CU(s) an LTM Cell Deactivation Request (e.g., including the OD-SSB deactivation for the cells of LTM_cell_todeactivate_list1 or an SSB adjustment (e.g., including preferred SSB adjustment parameters based on a selected configuration from the LTM_cell_adjustSSB_list of each cell of LTM_cell_todeactivate_list1)). Additionally, or alternatively, the request for LTM cell deactivation may be transmitted with LTM Cell Activation Request message with “deactivation” indicated or flagged.

As illustrated at 5, based on the request from the serving CU and other messages received from its Candidate DUs (e.g., similar to steps 2b and 2c), the candidate CU(s) may decide to deactivate a second subset of the Candidate CU(s)′ active LTM candidate cells (e.g., LTM_cell_todeactivate_list2) with SSB adaptation (e.g., including OD-SSB deactivation and/or SSB adjustment (e.g., a longer period for less frequent transmissions) of a second subset of the Candidate CU(s)′ active LTM candidate cells (e.g., LTM_cell_todeactivate_list2)).

As illustrated at 6, the candidate CU(s) may notify its candidate DU(s) via a Notification of LTM Cell Deactivation (e.g., with LTM_cell_todeactivate_list2). Additionally, the Notification of LTM Cell Deactivation may also include OD-SSB Deactivation indications (e.g., with the OD-SSB deactivation indication or flag set for the cells of LTM_cell_todeactivate_list2 to be deactivated) or SSB adjustment parameters (e.g., with a longer period for less frequent transmissions based on a selected configuration from the LTM_cell_adjustSSBconfig_list for each cell of LTM_cell_todeactivate_list2 to be deactivated). Additionally, or alternatively, the notification of LTM cell deactivation may be transmitted with Notification of LTM Cell Activation message with “deactivation” indicated or flagged.

As illustrated at 7, the candidate CU(s) may send the serving CU an LTM Cell Deactivation Response with OD-SSB deactivation (e.g., including the OD-SSB deactivation for the cells of LTM_cell_todeactivate_list2) or SSB adjustment (e.g., including preferred SSB parameters based on a selected configuration from the LTM_cell_adjustSSB_list of each cell of LTM_cell_todeactivate_list2). Additionally, or alternatively, the response to LTM cell deactivation may be transmitted with LTM Cell Activation Response message with “deactivation” indicated or flagged.

As illustrated at 8, the serving CU may notify its DUs via a Notification of LTM Cell Deactivation (e.g., with LTM_cell_todeactivate_list2). Additionally, the Notification of LTM Cell Deactivation may also include OD-SSB deactivation indications (e.g., with the OD-SSB deactivation indication or flag set for the cells of LTM_cell_todeactivate_list2 to be deactivated) or SSB adjustment parameters (e.g., with a longer period for less frequent transmissions based on a selected configuration from the LTM_cell_adjustSSBconfig_list for each cell of LTM_cell_todeactivate_list2 to be deactivated).

As illustrated at 9, the DUs may transmit an Indication of LTM Cell Deactivation (e.g., with OD-SSB deactivation or SSB adjustment indicated for the cells of LTM_cell_todeactivate_list2 to be deactivated). This SSB adaptation indication may be sent, for example, via MAC CE or DCI with a bitmap or flag for OD-SSB Deactivation or with a larger period value or configuration index/code point of LTM_cell_adjustSSBconfig_list for SSB adjustment for the cells of LTM_cell_deactivate_list2 to be deactivated.

In some aspects, the indication of SSB adaptation (e.g., including the indication of OD-SSB termination and/or the indication of SSB adjustment) may be transmitted separately to the UE following the indication of LTM candidate cell deactivation.

### Example Operations

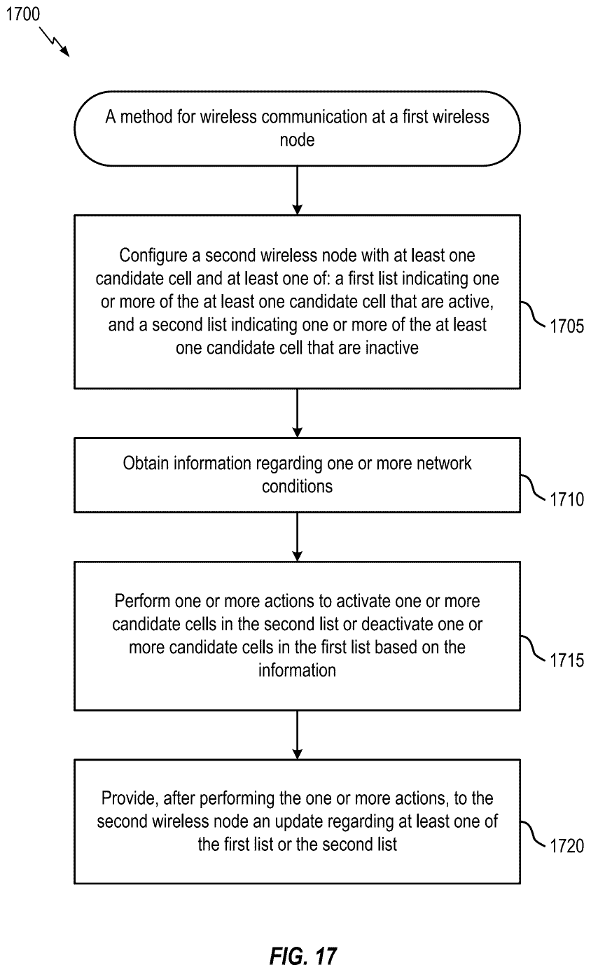

FIG. 17 shows an example of a method 1700 of wireless communication at a first wireless node, such as a BS 102 of FIGS. 1 and 3, or a disaggregated base station as discussed with respect to FIG. 2.

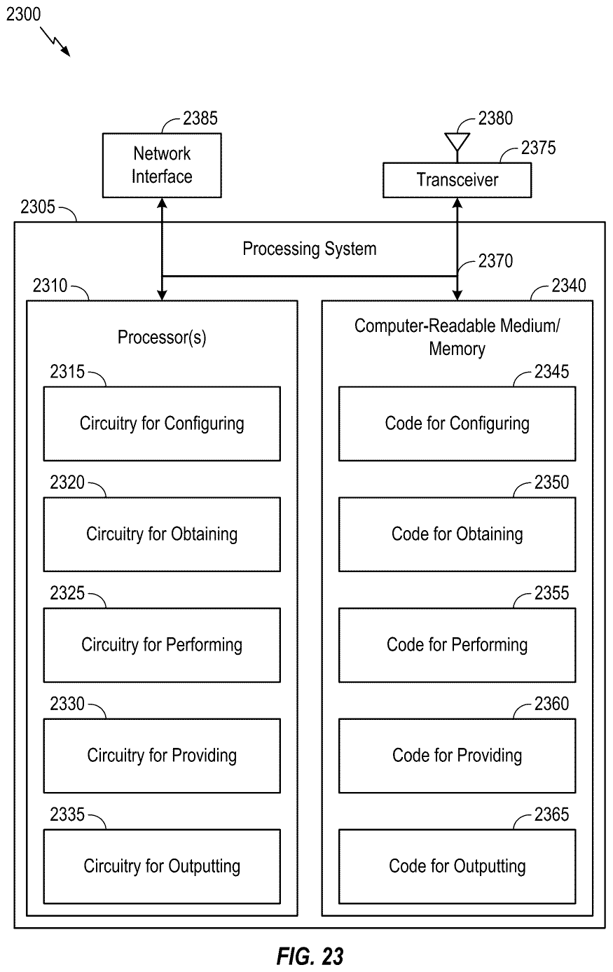

Method 1700 begins at step 1705 with configuring a second wireless node with at least one candidate cell and at least one of: a first list indicating one or more of the at least one candidate cell that are active, and a second list indicating one or more of the at least one candidate cell that are inactive. In some cases, the operations of this step refer to, or may be performed by, circuitry for configuring and/or code for configuring as described with reference to FIG. 23.

Method 1700 then proceeds to step 1710 with obtaining information regarding one or more network conditions. In some cases, the operations of this step refer to, or may be performed by, circuitry for obtaining and/or code for obtaining as described with reference to FIG. 23.

Method 1700 then proceeds to step 1715 with performing one or more actions to activate one or more candidate cells in the second list or deactivate one or more candidate cells in the first list based on the information. In some cases, the operations of this step refer to, or may be performed by, circuitry for performing and/or code for performing as described with reference to FIG. 23.

Method 1700 then proceeds to step 1720 with providing, after performing the one or more actions, to the second wireless node an update regarding at least one of the first list or the second list. In some cases, the operations of this step refer to, or may be performed by, circuitry for providing and/or code for providing as described with reference to FIG. 23.

In some aspects, the information is obtained via at least one of: a first status report from a serving cell serving the second wireless node; a second status report from at least one of the at least one candidate cell; a measurement report from the wireless node; a candidate cell activation request; or a candidate cell deactivation request.

In some aspects, at least one of the first status report or second status report comprises a warning message.

In some aspects, the information relates to at least one of: loading of one or more processing resources; loading of one or more network resources; power consumption or energy consumption; a first quantity of one or more wireless nodes observing one or more cell measurements being equal to or greater than a first threshold; or a second quantity of wireless nodes observing cell measurements being equal to or lower than a second threshold.

In some aspects, the one or more actions are performed to activate one or more of the candidate cells and the one or more actions comprise: outputting one or more cell activation requests.

In some aspects, the one or more actions further comprise at least one of: obtaining one or more responses to the one or more cell activation requests; or obtaining one or more cell activation complete messages, wherein the first wireless node provides the update only after obtaining at least one of the one or more responses or the one or more cell activation complete messages.

In some aspects, the one or more actions are performed to deactivate at least one of the one or more of the at least one candidate cell and the one or more actions comprise: outputting one or more cell deactivation requests.

In some aspects, the one or more actions further comprise at least one of: obtaining one or more responses to the one or more cell deactivation requests; or obtaining one or more cell deactivation complete messages, wherein the first wireless node provides the update only after obtaining the one or more responses or the one or more cell deactivation complete messages.

In some aspects, the one or more actions further comprise: outputting, to a first cell serving the second wireless node, a cell deactivation request; and obtaining, from the first cell, a message confirming deactivation of the first cee.

In some aspects, the at least one candidate cell comprises: a first subset of candidate cells managed by the first wireless node; and a second subset of candidate cells managed by another wireless node.

In some aspects, the one or more actions comprise at least one of: outputting, to the other entity, a request to deactivate one of the candidate cells of the second subset; or outputting, to the other entity, a request to activate one of the candidate cells of the second subset.

In one aspect, method 1700, or any aspect related to it, may be performed by an apparatus, such as communications device 2300 of FIG. 23, which includes various components operable, configured, or adapted to perform the method 1700. Communications device 2300 is described below in further detail.

Note that FIG. 17 is just one example of a method, and other methods including fewer, additional, or alternative steps are possible consistent with this disclosure.

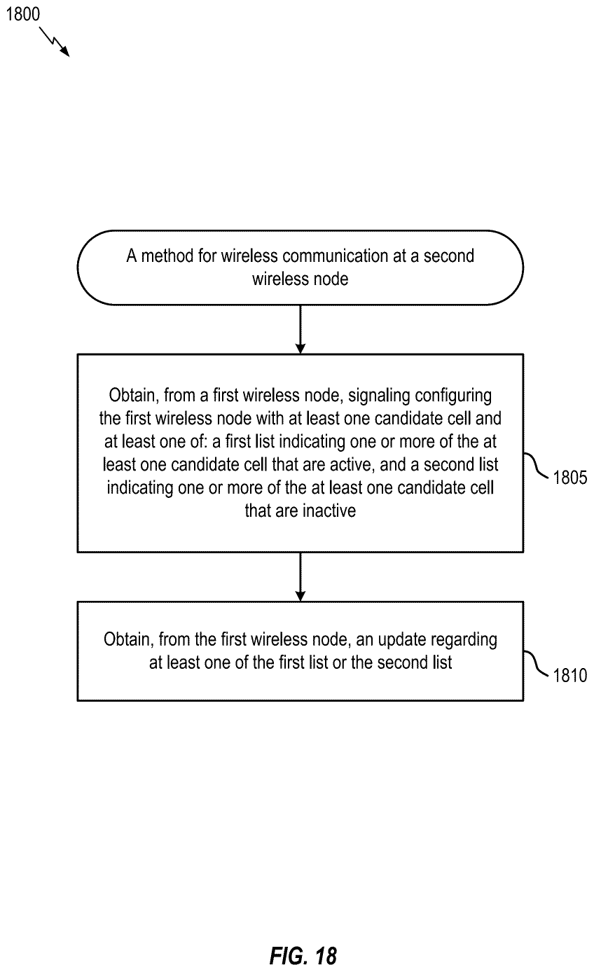

FIG. 18 shows an example of a method 1800 of wireless communication at a second wireless node, such as a UE 104 of FIGS. 1 and 3.

Method 1800 begins at step 1805 with obtaining, from a first wireless node, signaling configuring the first wireless node with at least one candidate cell and at least one of: a first list indicating one or more of the at least one candidate cell that are active, and a second list indicating one or more of the at least one candidate cell that are inactive. In some cases, the operations of this step refer to, or may be performed by, circuitry for obtaining and/or code for obtaining as described with reference to FIG. 23.

Method 1800 then proceeds to step 1810 with obtaining, from the first wireless node, an update regarding at least one of the first list or the second list. In some cases, the operations of this step refer to, or may be performed by, circuitry for obtaining and/or code for obtaining as described with reference to FIG. 23.

In some aspects, the method 1800 further includes outputting, to the wireless node, information regarding one or more network conditions, wherein the information is output via at least one of: a status report, a measurement report, a candidate cell activation request, or a candidate cell deactivation request. In some cases, the operations of this step refer to, or may be performed by, circuitry for outputting and/or code for outputting as described with reference to FIG. 23.

In some aspects, the status report comprises a warning message.

In one aspect, method 1800, or any aspect related to it, may be performed by an apparatus, such as communications device 2300 of FIG. 23, which includes various components operable, configured, or adapted to perform the method 1800. Communications device 2300 is described below in further detail.

Note that FIG. 18 is just one example of a method, and other methods including fewer, additional, or alternative steps are possible consistent with this disclosure.

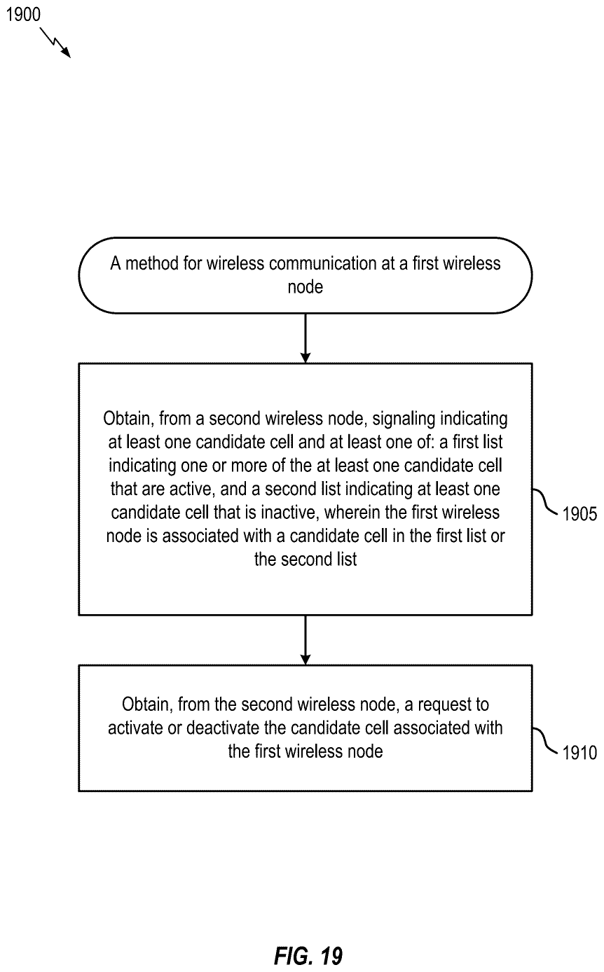

FIG. 19 shows an example of a method 1900 of wireless communication at a first wireless node, such as a BS 102 of FIGS. 1 and 3, or a disaggregated base station as discussed with respect to FIG. 2.

Method 1900 begins at step 1905 with obtaining, from a second wireless node, signaling indicating at least one candidate cell and at least one of: a first list indicating one or more of the at least one candidate cell that are active, and a second list indicating at least one candidate cell that is inactive, wherein the first wireless node is associated with a candidate cell in the first list or the second list. In some cases, the operations of this step refer to, or may be performed by, circuitry for obtaining and/or code for obtaining as described with reference to FIG. 23.

Method 1900 then proceeds to step 1910 with obtaining, from the second wireless node, a request to activate or deactivate the candidate cell associated with the first wireless node. In some cases, the operations of this step refer to, or may be performed by, circuitry for obtaining and/or code for obtaining as described with reference to FIG. 23.

In some aspects, the method 1900 further includes outputting, to the wireless node, information regarding one or more network conditions, wherein the information is provided via at least one of: a status report, a candidate cell activation request, or a candidate cell deactivation request. In some cases, the operations of this step refer to, or may be performed by, circuitry for outputting and/or code for outputting as described with reference to FIG. 23.

In some aspects, the status report comprises a warning message.

In some aspects, the information relates to at least one of: loading of one or more processing resources; loading of one or more network resources; power consumption or energy consumption; a first quantity of one or more wireless nodes observing one or more cell measurements being equal to or greater than a first threshold; or a second quantity of wireless nodes observing cell measurements being equal to or lower than a second threshold.

In one aspect, method 1900, or any aspect related to it, may be performed by an apparatus, such as communications device 2300 of FIG. 23, which includes various components operable, configured, or adapted to perform the method 1900. Communications device 2300 is described below in further detail.

Note that FIG. 19 is just one example of a method, and other methods including fewer, additional, or alternative steps are possible consistent with this disclosure.

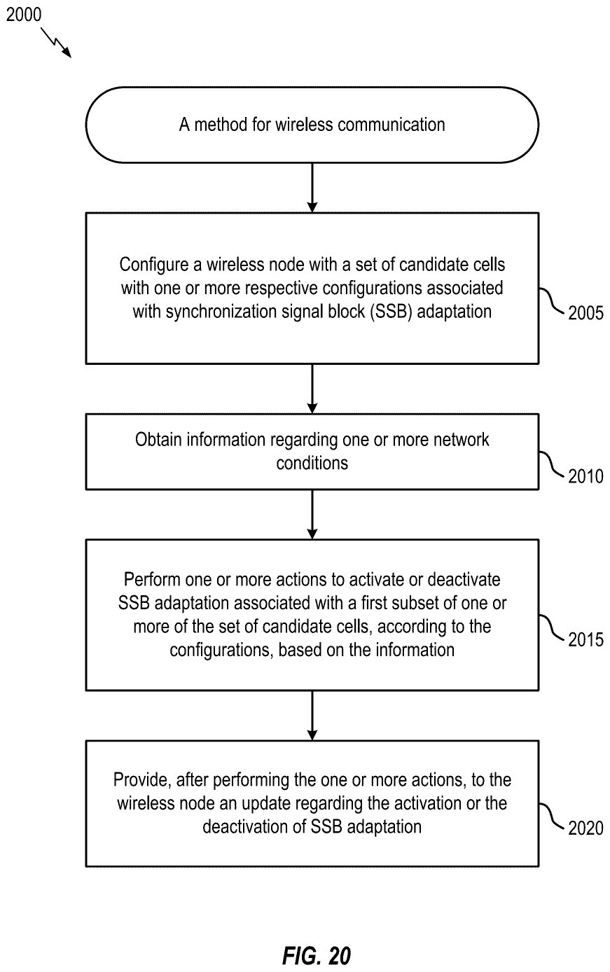

FIG. 20 shows an example of a method 2000 of wireless communication at a wireless node, such as a BS 102 of FIGS. 1 and 3, or a disaggregated base station as discussed with respect to FIG. 2.

Method 2000 begins at step 2005 with configuring a wireless node with a set of candidate cells with one or more respective configurations associated with synchronization signal block (SSB) adaptation. In some cases, the operations of this step refer to, or may be performed by, circuitry for configuring and/or code for configuring as described with reference to FIG. 23.

Method 2000 then proceeds to step 2010 with obtaining information regarding one or more network conditions. In some cases, the operations of this step refer to, or may be performed by, circuitry for obtaining and/or code for obtaining as described with reference to FIG. 23.

Method 2000 then proceeds to step 2015 with performing one or more actions to activate or deactivate SSB adaptation associated with a first subset of one or more of the set of candidate cells, according to the configurations, based on the information. In some cases, the operations of this step refer to, or may be performed by, circuitry for performing and/or code for performing as described with reference to FIG. 23.

Method 2000 then proceeds to step 2020 with providing, after performing the one or more actions, to the wireless node an update regarding the activation or the deactivation of SSB adaptation. In some cases, the operations of this step refer to, or may be performed by, circuitry for providing and/or code for providing as described with reference to FIG. 23.

In some aspects, at least a first configuration of the configurations for SSB adaptation is configured to enable on-demand SSB transmissions during a period of time.

In some aspects, at least a second configuration of the configurations for SSB adaptation is configured to enable SSB transmissions at different periodicities.

In some aspects, the one or more actions are performed to activate the SSB adaptation according to at least the first configuration or the second configuration, and the one or more actions comprise outputting, to one or more cells of the first subset, one or more notifications of the activation of SSB adaptation.

In some aspects, the one or more notifications indicate one or more SSB transmission parameters that are based on the first configuration or the second configuration.

In some aspects, the one or more actions are performed to deactivate the SSB adaptation according to at least the first configuration or the second configuration; and the one or more actions comprise outputting, to one or more cells of the first subset, one or more notifications of the deactivation of SSB adaptation.

In some aspects, the first subset comprises one or more candidate cells that are indicated as active and a second subset comprises one or more candidate cells that are indicated as inactive.

In some aspects, the one or more actions are performed to activate the SSB adaptation associated with the first subset according to at least the first configuration or the second configuration; and the method further comprises obtaining, after the activation of SSB adaptation and from the wireless node, a report of SSB measurements.

In some aspects, the method 2000 further includes performing one or more actions, after obtaining the report, to activate at least one of candidate cells of the first subset. In some cases, the operations of this step refer to, or may be performed by, circuitry for performing and/or code for performing as described with reference to FIG. 23.

In some aspects, the one or more actions are performed to deactivate at least one of candidate cells of the second subset.

In some aspects, the method 2000 further includes performing one or more actions, wherein the one or more actions comprise: deactivating the SSB adaptation associated with the at least one of the second subset of candidate cells, wherein the deactivation is according to at least the first configuration, or changing the SSB adaptation associated with the at least one of the second subset of candidate cells, wherein the change is according to at least the second configuration. In some cases, the operations of this step refer to, or may be performed by, circuitry for performing and/or code for performing as described with reference to FIG. 23.

In some aspects, the information is obtained via at least one of: a first status report from a serving cell serving the wireless node; a second status report from at least one of the set of candidate cells; a measurement report from the wireless node; an SSB adaptation activation request; or an SSB adaptation deactivation request.

In some aspects, at least one of the first status report or second status report comprises a warning message.

In some aspects, at least one of the first status report or the second status report comprises at least one of: loading of one or more processing resources; loading of one or more network resources; power consumption or energy consumption; a first quantity of one or more wireless nodes observing one or more cell measurements being equal to or greater than a first threshold; or a second quantity of wireless nodes observing cell measurements being equal to or lower than a second threshold.

In some aspects, the first subset comprises: one or more candidate cells managed by another wireless node.

In some aspects, the one or more actions comprise at least one of: outputting, to the other wireless node, one or more notifications of the activation of SSB adaptation; or outputting, to the other wireless node, one or more notifications of the deactivation of SSB adaptation.

In one aspect, method 2000, or any aspect related to it, may be performed by an apparatus, such as communications device 2300 of FIG. 23, which includes various components operable, configured, or adapted to perform the method 2000. Communications device 2300 is described below in further detail.

Note that FIG. 20 is just one example of a method, and other methods including fewer, additional, or alternative steps are possible consistent with this disclosure.

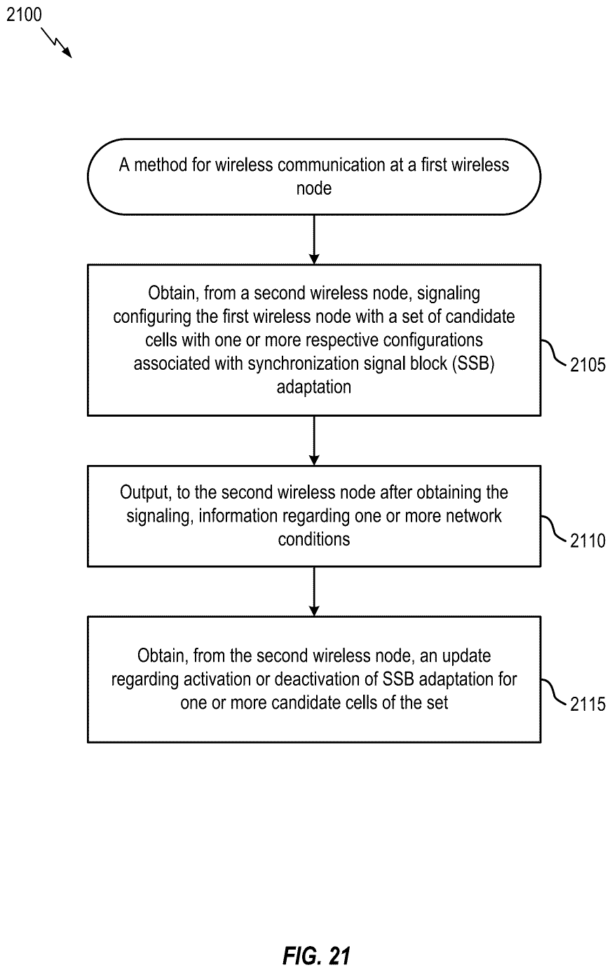

FIG. 21 shows an example of a method 2100 of wireless communication at a first wireless node, such as a UE 104 of FIGS. 1 and 3.

Method 2100 begins at step 2105 with obtaining, from a second wireless node, signaling configuring the first wireless node with a set of candidate cells with one or more respective configurations associated with synchronization signal block (SSB) adaptation. In some cases, the operations of this step refer to, or may be performed by, circuitry for obtaining and/or code for obtaining as described with reference to FIG. 23.

Method 2100 then proceeds to step 2110 with outputting, to the second wireless node after obtaining the signaling, information regarding one or more network conditions. In some cases, the operations of this step refer to, or may be performed by, circuitry for outputting and/or code for outputting as described with reference to FIG. 23.

Method 2100 then proceeds to step 2115 with obtaining, from the second wireless node, an update regarding activation or deactivation of SSB adaptation for one or more candidate cells of the set. In some cases, the operations of this step refer to, or may be performed by, circuitry for obtaining and/or code for obtaining as described with reference to FIG. 23.

In some aspects, at least a first configuration of the configurations for SSB adaptation is configured to enable on-demand SSB transmissions for a period of time.

In some aspects, at least a second configuration of the configurations for SSB adaptation is configured to enable SSB transmissions at different periodicities.

In some aspects, the information is output via at least one of: a status report; a measurement report; an SSB adaptation activation request; or an SSB adaptation deactivation request.

In some aspects, the status report comprises a warning message.

In one aspect, method 2100, or any aspect related to it, may be performed by an apparatus, such as communications device 2300 of FIG. 23, which includes various components operable, configured, or adapted to perform the method 2100. Communications device 2300 is described below in further detail.

Note that FIG. 21 is just one example of a method, and other methods including fewer, additional, or alternative steps are possible consistent with this disclosure.

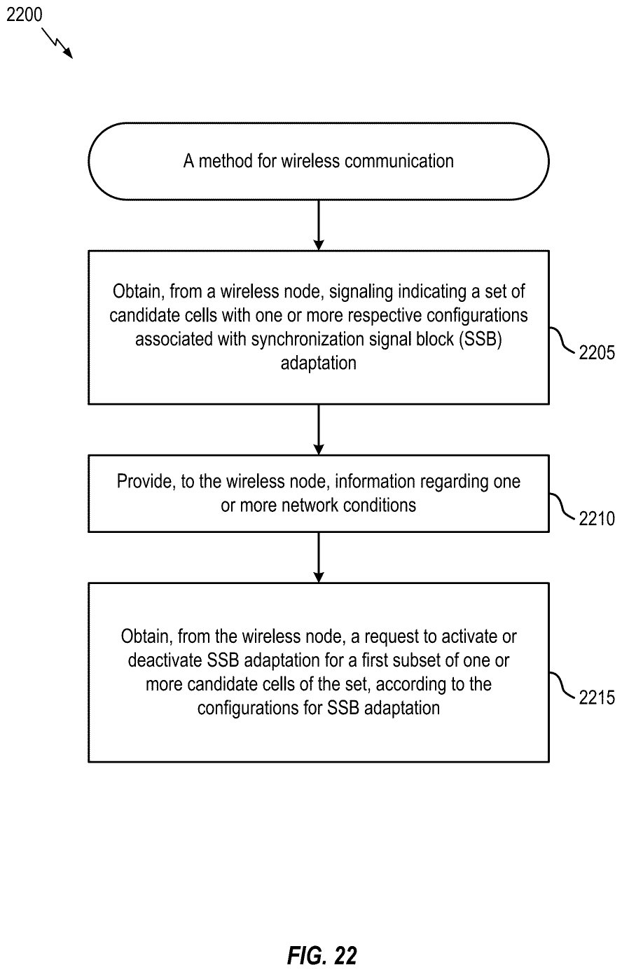

FIG. 22 shows an example of a method 2200 of wireless communication at a wireless node, such as a BS 102 of FIGS. 1 and 3, or a disaggregated base station as discussed with respect to FIG. 2.

Method 2200 begins at step 2205 with obtaining, from a wireless node, signaling indicating a set of candidate cells with one or more respective configurations associated with synchronization signal block (SSB) adaptation. In some cases, the operations of this step refer to, or may be performed by, circuitry for obtaining and/or code for obtaining as described with reference to FIG. 23.

Method 2200 then proceeds to step 2210 with providing, to the wireless node, information regarding one or more network conditions. In some cases, the operations of this step refer to, or may be performed by, circuitry for providing and/or code for providing as described with reference to FIG. 23.

Method 2200 then proceeds to step 2215 with obtaining, from the wireless node, a request to activate or deactivate SSB adaptation for a first subset of one or more candidate cells of the set, according to the configurations for SSB adaptation. In some cases, the operations of this step refer to, or may be performed by, circuitry for obtaining and/or code for obtaining as described with reference to FIG. 23.

In some aspects, at least a first configuration of the configurations for SSB adaptation is configured to enable on-demand SSB transmissions for a period of time.

In some aspects, at least a second configuration of the configurations for SSB adaptation is configured to enable SSB transmissions at different periodicities.

In some aspects, the information is provided via at least one of: a status report; an SSB adaptation activation request; or an SSB adaptation deactivation request.

In some aspects, the status report comprises a warning message.

In some aspects, the status report comprises at least one of: loading of one or more processing resources; loading of one or more network resources; power consumption or energy consumption; a first quantity of one or more wireless nodes observing one or more cell measurements being equal to or greater than a first threshold; or a second quantity of wireless nodes observing cell measurements being equal to or lower than a second threshold.

In one aspect, method 2200, or any aspect related to it, may be performed by an apparatus, such as communications device 2300 of FIG. 23, which includes various components operable, configured, or adapted to perform the method 2200. Communications device 2300 is described below in further detail.

Note that FIG. 22 is just one example of a method, and other methods including fewer, additional, or alternative steps are possible consistent with this disclosure.

### Example Communications Device(s)

FIG. 23 depicts aspects of an example communications device 2300. In some aspects, communications device 2300 is a user equipment, such as UE 104 described above with respect to FIGS. 1 and 3. In some aspects, communications device 2300 is a network entity, such as BS 102 of FIGS. 1 and 3, or a disaggregated base station as discussed with respect to FIG. 2.

The communications device 2300 includes a processing system 2305 coupled to the transceiver 2375 (e.g., a transmitter and/or a receiver). In some aspects (e.g., when communications device 2300 is a network entity), processing system 2305 may be coupled to a network interface 2385 that is configured to obtain and send signals for the communications device 2300 via communication link(s), such as a backhaul link, midhaul link, and/or fronthaul link as described herein, such as with respect to FIG. 2. The transceiver 2375 is configured to transmit and receive signals for the communications device 2300 via the antenna 2380, such as the various signals as described herein. The processing system 2305 may be configured to perform processing functions for the communications device 2300, including processing signals received and/or to be transmitted by the communications device 2300.

The processing system 2305 includes one or more processors 2310. In various aspects, the one or more processors 2310 may be representative of one or more of receive processor 358, transmit processor 364, TX MIMO processor 366, and/or controller/processor 380, as described with respect to FIG. 3. In various aspects, one or more processors 2310 may be representative of one or more of receive processor 338, transmit processor 320, TX MIMO processor 330, and/or controller/processor 340, as described with respect to FIG. 3. The one or more processors 2310 are coupled to a computer-readable medium/memory 2340 via a bus 2370. In certain aspects, the computer-readable medium/memory 2340 is configured to store instructions (e.g., computer-executable code) that when executed by the one or more processors 2310, cause the one or more processors 2310 to perform the method 1700 described with respect to FIG. 17, or any aspect related to it; the method 1800 described with respect to FIG. 18, or any aspect related to it; and the method 1900 described with respect to FIG. 19, or any aspect related to it; the method 2000 described with respect to FIG. 20, or any aspect related to it; the method 2100 described with respect to FIG. 21, or any aspect related to it; and the method 2200 described with respect to FIG. 22, or any aspect related to it. Note that reference to a processor performing a function of communications device 2300 may include one or more processors 2310 performing that function of communications device 2300.

In the depicted example, computer-readable medium/memory 2340 stores code (e.g., executable instructions), such as code for configuring 2345, code for obtaining 2350, code for performing 2355, code for providing 2360, and code for outputting 2365. Processing of the code for configuring 2345, code for obtaining 2350, code for performing 2355, code for providing 2360, and code for outputting 2365 may cause the communications device 2300 to perform the method 1700 described with respect to FIG. 17, or any aspect related to it; the method 1800 described with respect to FIG. 18, or any aspect related to it; and the method 1900 described with respect to FIG. 19, or any aspect related to it; the method 2000 described with respect to FIG. 20, or any aspect related to it; the method 2100 described with respect to FIG. 21, or any aspect related to it; and the method 2200 described with respect to FIG. 22, or any aspect related to it.

The one or more processors 2310 include circuitry configured to implement (e.g., execute) the code stored in the computer-readable medium/memory 2340, including circuitry for configuring 2315, circuitry for obtaining 2320, circuitry for performing 2325, circuitry for providing 2330, and circuitry for outputting 2335. Processing with circuitry for configuring 2315, circuitry for obtaining 2320, circuitry for performing 2325, circuitry for providing 2330, and circuitry for outputting 2335 may cause the communications device 2300 to perform the method 1700 described with respect to FIG. 17, or any aspect related to it; the method 1800 described with respect to FIG. 18, or any aspect related to it; and the method 1900 described with respect to FIG. 19, or any aspect related to it; the method 2000 described with respect to FIG. 20, or any aspect related to it; the method 2100 described with respect to FIG. 21, or any aspect related to it; and the method 2200 described with respect to FIG. 22, or any aspect related to it.

Various components of the communications device 2300 may provide means for performing the method 1700 described with respect to FIG. 17, or any aspect related to it; the method 1800 described with respect to FIG. 18, or any aspect related to it; and the method 1900 described with respect to FIG. 19, or any aspect related to it; the method 2000 described with respect to FIG. 20, or any aspect related to it; the method 2100 described with respect to FIG. 21, or any aspect related to it; and the method 2200 described with respect to FIG. 22, or any aspect related to it. For example, means for transmitting, sending or outputting for transmission may include transceivers 354 and/or antenna(s) 352 of the UE 104 illustrated in FIG. 3, transceivers 332 and/or antenna(s) 334 of the BS 102 illustrated in FIG. 3, and/or the transceiver 2375 and the antenna 2380 of the communications device 2300 in FIG. 23. Means for receiving or obtaining may include transceivers 354 and/or antenna(s) 352 of the UE 104 illustrated in FIG. 3, transceivers 332 and/or antenna(s) 334 of the BS 102 illustrated in FIG. 3, and/or the transceiver 2375 and the antenna 2380 of the communications device 2300 in FIG. 23.

### Example Clauses

Implementation examples are described in the following numbered clauses:
Clause 1: A method for wireless communication at a first wireless node, comprising: configuring a second wireless node with at least one candidate cell and at least one of: a first list indicating one or more of the at least one candidate cell that are active, and a second list indicating one or more of the at least one candidate cell that are inactive; obtaining information regarding one or more network conditions; performing one or more actions to activate one or more candidate cells in the second list or deactivate one or more candidate cells in the first list based on the information; and providing, after performing the one or more actions, to the second wireless node an update regarding at least one of the first list or the second list.
Clause 2: The method of Clause 1, wherein the information is obtained via at least one of: a first status report from a serving cell serving the second wireless node; a second status report from at least one of the at least one candidate cell; a measurement report from the wireless node; a candidate cell activation request; or a candidate cell deactivation request.
Clause 3: The method of Clause 2, wherein at least one of the first status report or second status report comprises a warning message.
Clause 4: The method of any one of Clauses 1-3, wherein the information relates to at least one of: loading of one or more processing resources; loading of one or more network resources; power consumption or energy consumption; a first quantity of one or more wireless nodes observing one or more cell measurements being equal to or greater than a first threshold; or a second quantity of wireless nodes observing cell measurements being equal to or lower than a second threshold.
Clause 5: The method of any one of Clauses 1-4, wherein the one or more actions are performed to activate one or more of the candidate cells and the one or more actions comprise: outputting one or more cell activation requests.
Clause 6: The method of Clause 5, wherein the one or more actions further comprise at least one of: obtaining one or more responses to the one or more cell activation requests; or obtaining one or more cell activation complete messages, wherein the first wireless node provides the update only after obtaining at least one of the one or more responses or the one or more cell activation complete messages.
Clause 7: The method of any one of Clauses 1-6, wherein the one or more actions are performed to deactivate at least one of the one or more of the at least one candidate cell and the one or more actions comprise: outputting one or more cell deactivation requests.
Clause 8: The method of Clause 7, wherein the one or more actions further comprise at least one of: obtaining one or more responses to the one or more cell deactivation requests; or obtaining one or more cell deactivation complete messages, wherein the first wireless node provides the update only after obtaining the one or more responses or the one or more cell deactivation complete messages.
Clause 9: The method of Clause 7, wherein the one or more actions further comprise: outputting, to a first cell serving the second wireless node, a cell deactivation request; and obtaining, from the first cell, a message confirming deactivation of the first cee.
Clause 10: The method of any one of Clauses 1-9, wherein the at least one candidate cell comprises: a first subset of candidate cells managed by the first wireless node; and a second subset of candidate cells managed by another wireless node.
Clause 11: The method of Clause 10, wherein the one or more actions comprise at least one of: outputting, to the other entity, a request to deactivate one of the candidate cells of the second subset; or outputting, to the other entity, a request to activate one of the candidate cells of the second subset.
Clause 12: A method for wireless communication at a second wireless node, comprising: obtaining, from a first wireless node, signaling configuring the first wireless node with at least one candidate cell and at least one of: a first list indicating one or more of the at least one candidate cell that are active, and a second list indicating one or more of the at least one candidate cell that are inactive; and obtaining, from the first wireless node, an update regarding at least one of the first list or the second list.
Clause 13: The method of Clause 12, further comprising outputting, to the wireless node, information regarding one or more network conditions, wherein the information is output via at least one of: a status report, a measurement report, a candidate cell activation request, or a candidate cell deactivation request.
Clause 14: The method of Clause 13, wherein the status report comprises a warning message.
Clause 15: A method for wireless communication at a first wireless node, comprising: obtaining, from a second wireless node, signaling indicating at least one candidate cell and at least one of: a first list indicating one or more of the at least one candidate cell that are active, and a second list indicating at least one candidate cell that is inactive, wherein the first wireless node is associated with a candidate cell in the first list or the second list; and obtaining, from the second wireless node, a request to activate or deactivate the candidate cell associated with the first wireless node.
Clause 16: The method of Clause 15, further comprising outputting, to the wireless node, information regarding one or more network conditions, wherein the information is provided via at least one of: a status report, a candidate cell activation request, or a candidate cell deactivation request.
Clause 17: The method of Clause 16, wherein the status report comprises a warning message.
Clause 18: The method of Clause 16, wherein the information relates to at least one of: loading of one or more processing resources; loading of one or more network resources; power consumption or energy consumption; a first quantity of one or more wireless nodes observing one or more cell measurements being equal to or greater than a first threshold; or a second quantity of wireless nodes observing cell measurements being equal to or lower than a second threshold.
Clause 19: A method for wireless communication, comprising: configuring a wireless node with a set of candidate cells with one or more respective configurations associated with synchronization signal block (SSB) adaptation; obtaining information regarding one or more network conditions; performing one or more actions to activate or deactivate SSB adaptation associated with a first subset of one or more of the set of candidate cells, according to the configurations, based on the information; and providing, after performing the one or more actions, to the wireless node an update regarding the activation or the deactivation of SSB adaptation.
Clause 20: The method of Clause 19, wherein at least a first configuration of the configurations for SSB adaptation is configured to enable on-demand SSB transmissions during a period of time.
Clause 21: The method of Clause 20, wherein at least a second configuration of the configurations for SSB adaptation is configured to enable SSB transmissions at different periodicities.
Clause 22: The method of any one of Clauses 19-21, wherein the information is obtained via at least one of: a first status report from a serving cell serving the wireless node; a second status report from at least one of the set of candidate cells; a measurement report from the wireless node; an SSB adaptation activation request; or an SSB adaptation deactivation request.
Clause 23: The method of Clause 22, wherein at least one of the first status report or second status report comprises a warning message.
Clause 24: The method of Clause 22, wherein at least one of the first status report or the second status report comprises at least one of: loading of one or more processing resources; loading of one or more network resources; power consumption or energy consumption; a first quantity of one or more wireless nodes observing one or more cell measurements being equal to or greater than a first threshold; or a second quantity of wireless nodes observing cell measurements being equal to or lower than a second threshold.
Clause 25: The method of Clause 21, wherein: the one or more actions are performed to activate the SSB adaptation according to at least the first configuration or the second configuration, and the one or more actions comprise outputting, to one or more cells of the first subset, one or more notifications of the activation of SSB adaptation.
Clause 26: The method of Clause 25, wherein the one or more notifications indicate one or more SSB transmission parameters that are based on the first configuration or the second configuration.
Clause 27: The method of Clause 21, wherein: the one or more actions are performed to deactivate the SSB adaptation according to at least the first configuration or the second configuration; and the one or more actions comprise outputting, to one or more cells of the first subset, one or more notifications of the deactivation of SSB adaptation.
Clause 28: The method of any one of Clauses 19-27, wherein the first subset comprises: one or more candidate cells managed by another wireless node.
Clause 29: The method of Clause 28, wherein the one or more actions comprise at least one of: outputting, to the other wireless node, one or more notifications of the activation of SSB adaptation; or outputting, to the other wireless node, one or more notifications of the deactivation of SSB adaptation.
Clause 30: The method of Clause 21, wherein: the first subset comprises one or more candidate cells that are indicated as active and a second subset comprises one or more candidate cells that are indicated as inactive.
Clause 31: The method of Clause 30, wherein: the one or more actions are performed to activate the SSB adaptation associated with the first subset according to at least the first configuration or the second configuration; and the method further comprises obtaining, after the activation of SSB adaptation and from the wireless node, a report of SSB measurements.
Clause 32: The method of Clause 31, further comprising performing one or more actions, after obtaining the report, to activate at least one of candidate cells of the first subset.
Clause 33: The method of Clause 30, wherein: the one or more actions are performed to deactivate at least one of candidate cells of the second subset.
Clause 34: The method of Clause 33, further comprising performing one or more actions, wherein the one or more actions comprise: deactivating the SSB adaptation associated with the at least one of the second subset of candidate cells, wherein the deactivation is according to at least the first configuration, or changing the SSB adaptation associated with the at least one of the second subset of candidate cells, wherein the change is according to at least the second configuration.
Clause 35: A method for wireless communication at a first wireless node, comprising: obtaining, from a second wireless node, signaling configuring the first wireless node with a set of candidate cells with one or more respective configurations associated with synchronization signal block (SSB) adaptation; outputting, to the second wireless node after obtaining the signaling, information regarding one or more network conditions; and obtaining, from the second wireless node, an update regarding activation or deactivation of SSB adaptation for one or more candidate cells of the set.
Clause 36: The method of Clause 35, wherein at least a first configuration of the configurations for SSB adaptation is configured to enable on-demand SSB transmissions for a period of time.
Clause 37: The method of any one of Clauses 35-36, wherein at least a second configuration of the configurations for SSB adaptation is configured to enable SSB transmissions at different periodicities.
Clause 38: The method of any one of Clauses 35-37, wherein the information is output via at least one of: a status report; a measurement report; an SSB adaptation activation request; or an SSB adaptation deactivation request.
Clause 39: The method of Clause 38, wherein the status report comprises a warning message.
Clause 40: A method for wireless communication, comprising: obtaining, from a wireless node, signaling indicating a set of candidate cells with one or more respective configurations associated with synchronization signal block (SSB) adaptation; providing, to the wireless node, information regarding one or more network conditions; and obtaining, from the wireless node, a request to activate or deactivate SSB adaptation for a first subset of one or more candidate cells of the set, according to the configurations for SSB adaptation.
Clause 41: The method of Clause 40, wherein at least a first configuration of the configurations for SSB adaptation is configured to enable on-demand SSB transmissions for a period of time.
Clause 42: The method of any one of Clauses 40-41, wherein at least a second configuration of the configurations for SSB adaptation is configured to enable SSB transmissions at different periodicities.
Clause 43: The method of any one of Clauses 40-42, wherein the information is provided via at least one of: a status report; an SSB adaptation activation request; or an SSB adaptation deactivation request.
Clause 44: The method of Clause 43, wherein the status report comprises a warning message.
Clause 45: The method of Clause 43, wherein the status report comprises at least one of: loading of one or more processing resources; loading of one or more network resources; power consumption or energy consumption; a first quantity of one or more wireless nodes observing one or more cell measurements being equal to or greater than a first threshold; or a second quantity of wireless nodes observing cell measurements being equal to or lower than a second threshold.
Clause 46: An apparatus, comprising: at least one memory comprising executable instructions; and at least one processor configured to execute the executable instructions and cause the apparatus to perform a method in accordance with any combination of Clauses 1-18.
Clause 47: An apparatus, comprising means for performing a method in accordance with any combination of Clauses 1-18.
Clause 48: A non-transitory computer-readable medium comprising executable instructions that, when executed by at least one processor of an apparatus, cause the apparatus to perform a method in accordance with any combination of Clauses 1-18.
Clause 49: A computer program product embodied on a computer-readable storage medium comprising code for performing a method in accordance with any combination of Clauses 1-18.
Clause 50: A wireless node (e.g., a network entity, such as a CU), comprising at least one transceiver; at least one memory comprising executable instructions; and at least one processor configured to execute the executable instructions to cause the apparatus to perform a method in accordance with any combination of Clauses 1-11, wherein the at least one transceiver is configured to receive the information regarding one or more network conditions.
Clause 51: A wireless node (e.g., a UE), comprising at least one transceiver; at least one memory comprising executable instructions; and at least one processor configured to execute the executable instructions to cause the apparatus to perform a method in accordance with any combination of Clauses 12-14, wherein the at least one transceiver is configured to receive the update regarding at least one of the first list or the second list.
Clause 52: A wireless node (e.g., a network entity, such as a DU), comprising at least one transceiver; at least one memory comprising executable instructions; and at least one processor configured to execute the executable instructions to cause the apparatus to perform a method in accordance with any combination of Clauses 15-18, wherein the at least one transceiver is configured to receive the request to activate or deactivate the candidate cell associated with the first wireless node.
Clause 53: A wireless node (e.g., a network entity, such as a CU), comprising at least one transceiver; at least one memory comprising executable instructions; and at least one processor configured to execute the executable instructions to cause the apparatus to perform a method in accordance with any combination of Clauses 19-34, wherein the at least one transceiver is configured to receive the information regarding one or more network conditions.
Clause 54: A wireless node (e.g., a UE), comprising at least one transceiver; at least one memory comprising executable instructions; and at least one processor configured to execute the executable instructions to cause the apparatus to perform a method in accordance with any combination of Clauses 35-39, wherein the at least one transceiver is configured to transmit the information regarding one or more network conditions.
Clause 55: A wireless node (e.g., a network entity, such as a DU), comprising at least one transceiver; at least one memory comprising executable instructions; and at least one processor configured to execute the executable instructions to cause the apparatus to perform a method in accordance with any combination of Clauses 40-45, wherein the at least one transceiver is configured to receive the signaling.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a graphics processing unit (GPU), a neural processing unit (NPU), a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, “a processor,” “at least one processor” or “one or more processors” generally refers to a single processor configured to perform one or multiple operations or multiple processors configured to collectively perform one or more operations. In the case of multiple processors, performance of the one or more operations could be divided amongst different processors, though one processor may perform multiple operations, and multiple processors could collectively perform a single operation. Similarly, “a memory,” “at least one memory” or “one or more memories” generally refers to a single memory configured to store data and/or instructions, multiple memories configured to collectively store data and/or instructions.

In some cases, rather than actually transmitting a signal, an apparatus (e.g., a wireless node or device) may have an interface to output the signal for transmission. For example, a processor may output a signal, via a bus interface, to a radio frequency (RF) front end for transmission. Accordingly, a means for outputting may include such an interface as an alternative (or in addition) to a transmitter or transceiver. Similarly, rather than actually receiving a signal, an apparatus (e.g., a wireless node or device) may have an interface to obtain a signal from another device. For example, a processor may obtain (or receive) a signal, via a bus interface, from an RF front end for reception. Accordingly, a means for obtaining may include such an interface as an alternative (or in addition) to a receiver or transceiver.

While the present disclosure may describe certain operations as being performed by one type of wireless node, the same or similar operations may also be performed by another type of wireless node. For example, operations performed by a user equipment (UE) may also (or instead) be performed by a network entity (e.g., a base station or unit of a disaggregated base station). Similarly, operations performed by a network entity may also (or instead) be performed by a UE.

Further, while the present disclosure may describe certain types of communications between different types of wireless nodes (e.g., between a network entity and a UE), the same or similar types of communications may occur between same types of wireless nodes (e.g., between network entities or between UEs, in a peer-to-peer scenario). Further, communications may occur in reverse order than described.

Means for configuring, means for obtaining, means for performing, means for providing, and means for outputting may comprise one or more processors, such as one or more of the processors described above with reference to FIG. 16.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. An apparatus for wireless communication, comprising:
at least one memory comprising computer-executable instructions; and
one or more processors configured to execute the computer-executable instructions to cause the apparatus to:
configure a wireless node with at least one candidate cell and at least one of:
a first list indicating one or more of the at least one candidate cell that are active, and
a second list indicating one or more of the at least one candidate cell that are inactive;
obtain information regarding one or more network conditions;
perform one or more actions to activate one or more candidate cells in the second list or deactivate one or more candidate cells in the first list based on the information; and
provide, after performing the one or more actions, to the wireless node an update regarding at least one of the first list or the second list.

2. The apparatus of claim 1, wherein the information is obtained via at least one of:
a first status report from a serving cell serving the wireless node;
a second status report from at least one of the at least one candidate cell;
a measurement report from the wireless node;
a candidate cell activation request; or
a candidate cell deactivation request.

3. The apparatus of claim 2, wherein at least one of the first status report or second status report comprises a warning message.

4. The apparatus of claim 1, wherein the information relates to at least one of:
loading of one or more processing resources;
loading of one or more network resources;
power consumption or energy consumption;
a first quantity of one or more wireless nodes observing one or more cell measurements being equal to or greater than a first threshold; or
a second quantity of wireless nodes observing cell measurements being equal to or lower than a second threshold.

5. The apparatus of claim 1, wherein the one or more actions are performed to activate one or more of the candidate cells and the one or more actions comprise:
outputting one or more cell activation requests.

6. The apparatus of claim 5, wherein the one or more actions further comprise at least one of:
obtaining one or more responses to the one or more cell activation requests; or
obtaining one or more cell activation complete messages, wherein the apparatus provides the update only after obtaining at least one of the one or more responses or the one or more cell activation complete messages.

7. The apparatus of claim 1, wherein the one or more actions are performed to deactivate at least one of the one or more of the at least one candidate cell and the one or more actions comprise:
outputting one or more cell deactivation requests.

8. The apparatus of claim 7, wherein the one or more actions further comprise at least one of:
obtaining one or more responses to the one or more cell deactivation requests; or
obtaining one or more cell deactivation complete messages, wherein the apparatus provides the update only after obtaining the one or more responses or the one or more cell deactivation complete messages.

9. The apparatus of claim 7, wherein the one or more actions further comprise:
outputting, to a first cell serving the wireless node, a cell deactivation request; and
obtaining, from the first cell, a message confirming deactivation of the first cee.

10. The apparatus of claim 1, wherein the at least one candidate cell comprises:
a first subset of candidate cells managed by the apparatus; and
a second subset of candidate cells managed by another wireless node.

11. The apparatus of claim 10, wherein the one or more actions comprise at least one of:
outputting, to the other entity, a request to deactivate one of the candidate cells of the second subset; or
outputting, to the other entity, a request to activate one of the candidate cells of the second subset.

12. The apparatus of claim 1, further comprising at least one transceiver configured to receive the information, wherein the apparatus is configured as a network entity.

13. An apparatus for wireless communication, comprising:
at least one memory comprising computer-executable instructions; and
one or more processors configured to execute the computer-executable instructions to cause the apparatus to:
obtain, from a wireless node, signaling configuring the apparatus with at least one candidate cell and at least one of:
a first list indicating one or more of the at least one candidate cell that are active, and
a second list indicating one or more of the at least one candidate cell that are inactive; and
obtaining, from the wireless node, an update regarding at least one of the first list or the second list.

14. The apparatus of claim 13, wherein:
the one or more processors are further configured to cause the apparatus to output, to the wireless node, information regarding one or more network conditions; and
the information is output via at least one of:
a status report;
a measurement report;
a candidate cell activation request; or
a candidate cell deactivation request.

15. The apparatus of claim 14, wherein the status report comprises a warning message.

16. The apparatus of claim 13, further comprising at least one transceiver configured to receive the update, wherein the apparatus is configured as a user equipment (UE).

17. An apparatus for wireless communication, comprising:
at least one memory comprising computer-executable instructions; and
one or more processors configured to execute the computer-executable instructions to cause the apparatus to:
obtain, from a wireless node, signaling indicating at least one candidate cell and at least one of:
a first list indicating one or more of the at least one candidate cell that are active, and
a second list indicating at least one candidate cell that is inactive, wherein the apparatus is associated with a candidate cell in the first list or the second list; and
obtain, from the wireless node, a request to activate or deactivate the candidate cell associated with the apparatus.

18. The apparatus of claim 17, wherein the one or more processors are further configured to cause the apparatus to output, to the wireless node, information regarding one or more network conditions; and
the information is provided via at least one of:
a status report;
a candidate cell activation request; or
a candidate cell deactivation request.

19. The apparatus of claim 18, wherein the status report comprises a warning message.

20. The apparatus of claim 18, wherein the information relates to at least one of:
loading of one or more processing resources;
loading of one or more network resources;
power consumption or energy consumption;
a first quantity of one or more wireless nodes observing one or more cell measurements being equal to or greater than a first threshold; or
a second quantity of wireless nodes observing cell measurements being equal to or lower than a second threshold.
